(19) United States
(12) Patent Application Publication
(10) Pub. No.: US 2017/0086488 A1
(43) Pub. Date: Mar. 30, 2017

(54) SEED COMPOSITION AND METHOD TO IMPROVE GERMINATION AND EMERGENCE UNDER ADVERSE SOIL CONDITIONS

(71) Applicant: AQUATROLS CORPORATION OF AMERICA, Paulsboro, NJ (US)

(72) Inventors: Mica Franklin McMILLAN, Davie, FL (US); Stanley J. KOSTKA, Cherry Hill, NJ (US)

(21) Appl. No.: 15/307,100

(22) PCT Filed: Jun. 16, 2015
(86) PCT No.: PCT/US15/36064

§ 371 Date: Oct. 27, 2016

Related U.S. Application Data
(60) Provisional application No. 62/012,754, filed on Jun. 16, 2014.
(60) Provisional application No. 62/029,246, filed on Jul. 25, 2014.
(60) Provisional application No. 62/055,386, filed on Sep. 25, 2014.

(51) Int. Cl. A23L 25/00; A01C 1/06

(52) U.S. Cl. CPC A23L 25/25; A01C 1/06; A23V 2002/00

(57) ABSTRACT

A seed composition, system, and method of improving seed germination, emergence, and seedling development are provided. The seed composition includes a seed, a binder, and a surfactant forming a first layer. The seed composition can have a second layer composed of a diatomaceous earth, lime, or clay and a binder and a third coating that includes a surfactant.

### BACKGROUND OF THE DISCLOSURE

1. Field of the Disclosure

The present disclosure generally relates to a seed composition and/or soil treatment to enhance seed germination, emergence, and seedling development. More particularly, the present disclosure relates to a seed composition and/or soil treatment that include a surfactant-based composition that enhances seed germination, seed emergence, and seedling growth and vigor under compromised water and soil conditions. A method and system for the same are also provided.

2. Field of the Related Art

A seed is an embryonic plant. Germination is the process by which a seed develops into a seedling. In order for a seed to germinate, the seed must be alive and viable, dormancy requirements must be met, and the proper environmental conditions must exist. Viability is the ability of the embryo to germinate. Numerous factors contribute to viability of a seed, including environmental conditions and environmental stressors. Basic environmental conditions include, water, oxygen, temperature, and light. Environmental stressors are environmental conditions that stress the seed and thus decrease the likelihood that the seed will germinate and develop into a seedling. Seed germination and emergence are influenced by water and oxygen availability, temperature, nutrition, and biological activity in the root zone. Many types of seeds are sensitive to their growing environments and require good environmental conditions in order to properly germinate and develop.

Of particular significance with regard to environmental conditions, especially with the global climate shifting, are stressors induced by water and irrigation. Plants and seeds respond to water. Plants are sensitive to water deficit and drought stresses.

A drought or dry period is an extended period during which there is a deficiency or shortage in water supply. The supply can be atmospheric, surface, or ground water. Periods of droughts can result in significant agricultural, social, economic consequences. For example, effects can be diminished crop growth, diminished yield, monetary losses, and even hunger in areas where a population relies on crop production for food. Water shortage in soils results in postponed and reduced seed germination, uneven and compromised seedling emergence, and varied number of plants per unit area and ultimately decreased stand performance, yield and quality.

Water deficits can also occur when less than an ideal amount of irrigation water is provided to seeds and plants. Deficit irrigation is an agricultural water management system in which less than 100% of the potential evapotranspiration can be provided by a combination of stored soil water, rainfall, and irrigation, during the growing season. As water supplies decline and the cost of water increases, it is clear that producers are being driven toward deficit irrigation management.

Evapotranspiration is a combination of water lost by evaporation from the soil surface and transpiration by the plant. Thus water must be replenished for the plant to survive.

Another significant environmental condition is salinity. Salinity can refer to both water and soil conditions. Plants are also sensitive to salt. Salinity is the saltiness or dissolved salt content of a body of water, a soil, or both.

Typically salt accumulation is most abundant at the soil surface, which is in close proximity to where seeds are sowed. Salts can be transported to the surface by capillary transport mechanisms. Salt accumulation can result from evaporation of water having a salt content, or can also be the result of fertilizer applications which themselves contain salts. Increased soil salinity can result in degraded soil and deteriorated vegetation establishment. High levels of soil salinity can be tolerated only if salt-tolerant plants are grown. Most crops are negatively affected by moderately saline soils, let alone severely saline soils.

High salinity irrigation water is an issue all over the world and will continue to be an issue as water demand increases. Desert regions such as New Mexico, California, and Texas are just a few of the areas where the only water supply is high saline water. Seeds are particularly negatively affected by high salts. High saline environments reduce seed germination, emergence, establishment and overall yield.

Soils can generally be grouped into two types. Those that behave as hydrophilic (water loving) are referred to as wettable. Those that are hydrophobic (water hating) are referred to as water repellent or may be non-wettable.

Hydrophobic or water repellent soils are difficult to wet. The soil particles are coated with materials such as waxes, mycelium, organic acids, or other organic materials that repel water. Uniform infiltration and percolation of water is impeded creating uneven wetting patterns at the soil surface and throughout the soil profile.

Soil surfactants are often used in agriculture, horticulture, turfgrass, and landscape markets to improve the wettability of soils. Surfactants have been proven to ameliorate water repellency, to enhance distribution of water throughout the soil profile and to reduce water use in many soil systems.

Wettable soils are those soils into which water readily infiltrates and percolates. These are soils which are able to retain water and are generally some of the most agriculturally productive.

Attempts have been made, and there is ongoing research, to use genetic modification to reduce water needs in plants and increase crop yields. However, there are countless concerns regarding genetically modifying crops, including unknown evolutionary consequences to crops and their ecosystem, safety for human consumption, and ethical concerns. Long term health effects in humans of consuming genetically modified crops are unknown. Plants having genetically modification have been shown to harm organs in animals such as the kidney, heart, and liver.

Accordingly, there is a need to improve germination rate, establishment rate, and overall quality of seeds and seedlings in wettable and non-wettable (water repellent) soil under drought conditions and/or reduced or deficit irrigation. Further, there is a need to improve germination rate, establishment rate, and overall quality of seeds and seedlings in wettable and non-wettable (water repellent) soil under high saline soil or water conditions. Yet further, there is a need to improve germination rate, establishment rate, and overall quality of seeds and seedlings in wettable and non-wettable (water repellent) soil under high saline water or soil conditions and drought conditions and/or reduced or deficit irrigation in combination. Still further, given the changing climate conditions and new challenges associated therewith, there is a need, not only to reduce water inputs, but also to enhance germination, emergence, and plant health, as well as to increase crop productivity, in a manner adaptive to resultant water shortages. There is a further need to achieve these results without the use of genetic modification or plant breeding.

### SUMMARY OF THE PRESENT DISCLOSURE

As used herein, adverse soil conditions means water drought conditions, deficit irrigation, saline irrigation water, high saline soil, combinations thereof, and the like. Compromised soil means soil that has a high salt content or soil that has insufficient water to support a seed, seedling, or plant. Compromised water condition means water that has a high salt content or water quantities that are below a seed, seedling, or plant's needs.

Water deficit includes deficit irrigation and drought conditions. Field Capacity is the optimum range of water availability. Permanent wilt point is the range where plants are no longer able to access water. Depending on texture, field capacity can range from 10%-42% and permanent wilt point 5%-30%, respectively. Water deficit means a water availability of between about 5% and about 30%.

A saline condition includes saline soil and severe ranges are dependent on soil texture. In soil, high salinity means a salt concentration of greater than about 4 ds/m ECe, preferably greater than about 6 ds/m ECe. In soil, severe salinity means a salt concentration of greater than about 13 ds/m, and more preferably, greater than about 20 ds/m. A saline condition includes saline water and severe ranges are dependent on soil texture. In irrigation water, high salinity means a salt concentration of greater than about 0.7 ds/m ECw, preferably greater than about 1 ds/m ECw, and most preferably greater than about 3 ds/m ECw.

The present disclosure provides a seed composition, and a method of making the seed composition, that improves seed germination, emergence, and growth when present in or subjected to soil that is exposed to drought conditions, deficit irrigation, saline irrigation water, high saline soil, and combinations thereof.

The present disclosure also provides a soil treatment and method of using the soil treatment that improves seed germination, emergence, and growth when a seed is present in, or subjected to, soil that is exposed to drought conditions, deficit irrigation, saline irrigation water, high saline soil, and combinations thereof.

The present disclosure also provides a system using a seed composition and soil treatment that improves seed germination, emergence, and growth in soil that is subjected to drought conditions, deficit irrigation, saline irrigation water, high saline soil, and combinations thereof.

The seed composition is a surfactant composition coated seed. The seed composition of the present disclosure, when planted in adverse soil conditions, or when soil conditions become adverse, exhibits similar seed germination, seed emergence, and seedling growth as if planted in uncompromised soil or exposed to uncompromised water.

The present disclosure also provides a system having the seed composition and optionally a surfactant soil treatment that improves seed germination, emergence, and growth under adverse soil conditions, compared to as if planted in uncompromised soil or exposed to uncompromised water.

The seed composition of the present disclosure, when subjected adverse soil conditions, exhibits better seed germination, seed emergence, and seedling growth than an uncoated seed subjected to the same.

The seed composition of the present disclosure results in plants with better vigor. Better vigor means stronger, healthier plants, even under deficit irrigation, drought conditions, saline soil, or saline irrigation.

The seed composition of the present disclosure provides growers the ability to both maximize the use of water and the harvest per unit land area. This results in economic savings from the cost of water and increased yield. Ancillary cost savings result from less fuel required to pump or move irrigation water. A grower is able to produce a better stand (generally tied to more above ground biomass). A grower using the seed composition of the present disclosure can have a greater probability of a better stand, producing more plants and fixing more carbon, even under deficit irrigation or drought conditions. Further, the effect can last for an extended period of time, such as, but not limited to 90 days. For some crops, this can be the entire season.

The seed composition of the present disclosure exhibits faster seedling emergence and results in more seedlings establishing, even under deficit irrigation or drought conditions, saline soil, or saline irrigation.

The seed composition of the present disclosure provides growers the ability to achieve parity performance with 50% less water.

A seed composition according to the present disclosure has a first coating that includes a surfactant, and a binder. A second coating composed of a diatomaceous earth, lime, or clay and a binder. A third coating includes a surfactant.

### BRIEF DESCRIPTION OF THE DRAWINGS

FIG. 1 is an illustration of coated seed according to an embodiment of the present disclosure.

FIG. 2 is an illustration of a coated seed according to another embodiment of the present disclosure.

FIG. 3 is an illustration of system having a coated seed and soil treatment according to the present disclosure.

### DETAILED DESCRIPTION OF THE DISCLOSURE

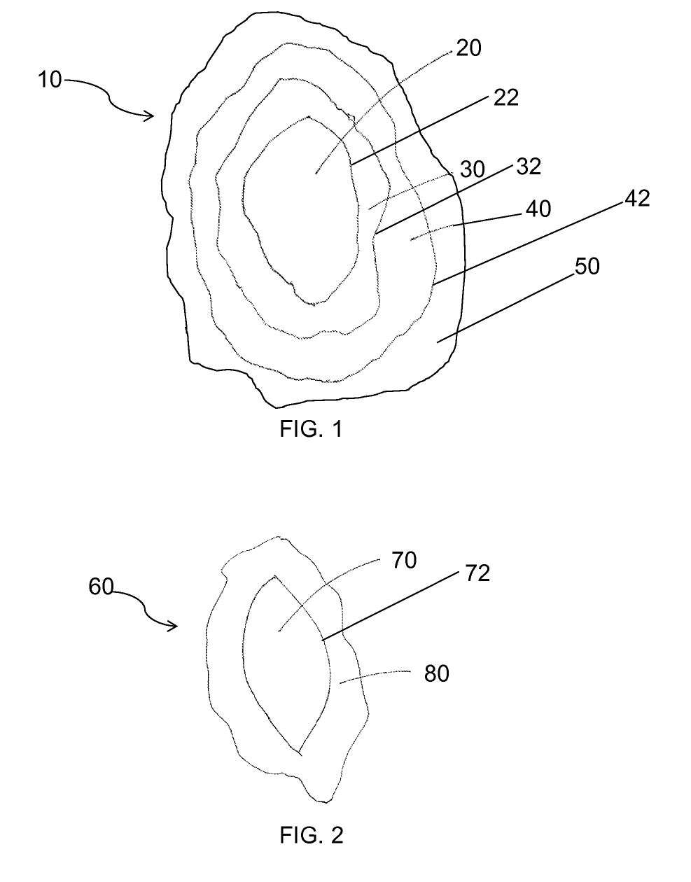

Referring now to the drawings and, in particular, FIG. 1, there is shown a seed composition generally represented by reference numeral 10. Seed composition 10 includes a seed 20 having an outer layer 22 (i.e., the seed coat).

A first coating 30 (also called a base coating in this application) having an outer surface 32 is disposed on outer layer 22. A second coating 40 (also called an inner coating herein) having an outer surface 42 can be disposed on outer surface 32. A third coating 50 (also called an outer coating in this application) can be disposed on outer surface 42.

In a preferred embodiment, first coating 30 is disposed on the entire outer layer 22 of seed 20 and completely encapsulates seed 20 therein. In an alternative embodiment, first coating 30 is disposed only on a first portion of outer layer 22, leaving a second portion of outer layer 22 uncovered by first coating 30.

In a preferred embodiment, first coating 30 has a thickness that is uniform, or substantially uniform, around the entire outer layer 22 of seed 20. In an alternative embodiment, first coating 30 has a variable thickness, and is considerably thicker on some portions of outer layer 22 than on other portions.

In a preferred embodiment, first coating 30 is made of a composition that forms a single layer that is homogeneous. In an alternative embodiment, first coating 30 is made of two or more separate, adjacent sublayers (not shown), in which each individual sublayer is a homogeneous mixture of two or more components of first coating 30, or, alternatively, in which each sublayer is a single component that is a different composition from the sublayer immediately adjacent thereto.

Similarly, in a preferred embodiment, second coating 40 is disposed on the entire outer surface 32 of first coating 30, and completely encapsulates first coating 30 and seed 20 therein. In an alternative embodiment, second coating 40 is disposed only on a first portion of outer surface 32, leaving a second portion of outer surface 32 that is uncovered by second coating 40.

In a preferred embodiment, second coating 40 has a thickness that is uniform, or substantially uniform, around the entire outer surface 32. In an alternative embodiment, second coating 40 has a variable thickness, and is considerably thicker on some portions of outer surface 32 than on other portions.

In a preferred embodiment, second coating 40 is made of a composition that forms a single layer that is homogeneous. In an alternative embodiment, second coating 40 is made of two or more separate, adjacent sublayers (not shown), in which each individual sublayer is a homogeneous mixture of two or more components of second coating 40, or, alternatively, in which each sublayer is a single component that is a different composition from the sublayer immediately adjacent.

Similar to first coating 30 and second coating 40, in a preferred embodiment, third coating 50 is disposed on the entire outer surface 42 of second coating 40, and completely encapsulates second coating 40, first coating 30, and seed 20 therein. In an alternative embodiment, third coating 50 is disposed only on a first portion of outer surface 42, leaving a second portion of outer surface 42 that is uncovered by third coating 50.

In a preferred embodiment, third coating 50 has a thickness that is uniform, or substantially uniform, around the entire outer surface 42. In an alternative embodiment, third coating 50 has a variable thickness, and is considerably thicker on some portions of outer surface 42 than on other portions.

In a preferred embodiment, third coating 50 is made of a composition that forms a single layer that is homogeneous. In an alternative embodiment, third coating 50 is made of two or more separate, adjacent sublayers (not shown), in which each individual sublayer is a homogeneous mixture of two or more components of third coating 50, or, alternatively, in which each sublayer is a single component that is a different composition from the sublayer immediately adjacent.

Referring now to FIG. 2, there is shown another embodiment of a seed composition generally represented by reference numeral 60 that includes a seed 70 having an outer layer 72 (i.e., the seed coat). A first coating 80 is disposed on outer layer 72.

As used herein, first coating 30 and first coating 80 are equivalent as are seed 10 and seed 60.

First coating 30 includes a non-ionic surfactant. The surfactant can be, but is not limited to an alkyl ether of methyl oxirane-oxirane copolymer, ethylene oxide-propylene oxide block copolymer, C₁-C₄ alkyl ether of ethylene oxide-propylene oxide block copolymer, alkyl polyglycoside, C₈-₁₀ Alkylpolyglucosides, a copolymer produced by the interaction of about 9 moles of ethylene oxide with about 2 moles of propylene oxide end-blocked with dimethyl ether (PEG/PPG-9/2 dimethyl ether), a copolymer produced by the interaction of about 3 moles of ethylene oxide with about 6 moles of propylene oxide end-blocked with dimethyl ether (PEG/PPG-3/6 dimethyl ether), Polyoxyethylene-Polyoxypropylene Block Co-polymer, a copolymer produced by the interaction of about 14 moles of ethylene oxide with about 7 moles of propylene oxide end-blocked with dimethyl ether (PEG/PPG-14/7 dimethyl ether), methyloxirane polymer with oxirane and dimethyl ether, alkoxylated polyol, glucoether surfactants, and mixtures thereof. ASET-4001 and ASET-4002 (Aquatrols® Corp., Paulsboro, N.J., U.S.A.) are examples of such surfactants.

The C₁-C₄ alkyl ethers of methyl oxirane-oxirane copolymers of the instant disclosure include, before etherification, the straight polymeric glycols obtained, for example, by the addition of ethylene oxide on propylene oxide structurally depicted as:

HO(CH₂CH₂O)ₓ(CH(CH₃)CH₂O)_{y}(CH2CH2O)_{z}H

The identical or different integers x,y, and z individually are greater than or equal to zero such that the desired propylene oxide and ethylene oxide mass average molecular weights and percentages are obtained. The polymethyloxirane cores, being hydrophobic, have units at least about 9, and are usually in the range of from about 950 to about 4,000 mass average molecular weight. The oxirane is added to the core at from about 10 weight percent to about 80 weight percent. In a preferred embodiment, the polymethyloxirane core mass average molecular weight is from about 1500 to about 2000 with oxirane addition of from about 20 to about 40 weight percent.

The preferred alkyl ethers of methyl oxirane-oxirane copolymers for use in this disclosure are those having an HLB value less than or equal to 10; an average molecular weight of from 2,000 to 8,000 and a percent hydrophile of from less than 10 to 40.

The ethylene oxide-propylene oxide (EO/PO) block copolymers of the instant disclosure include the straight block polymeric glycols obtained, for example, by the addition of ethylene oxide (EO) on a condensation product of propylene oxide (PO) with propylene glycol. The block polyoxypropylene cores, being the hydrophobe, have PO units at least about 9, and are usually in the range of from about 950 to about 4,000 mass average molecular weight. The ethylene oxide (EO) is added to the core at from about 10 weight percent to about 80 weight percent. In a preferred embodiment, the polyoxypropylene core mass average molecular weight is from about 1500 to about 2000 with EO addition of from about 20 to about 40 weight percent. Reverse block copolymers, which are also acceptable for use in the instant disclosure, are prepared by adding ethylene oxide to ethylene glycol to provide a hydrophile of designated molecular weight. Polypropylene oxide is then added to obtain hydrophobic blocks on the outside of the molecule. Reversing the hydrophobic and hydrophilic blocks creates surfactants similar to the regular EO/PO/EO block copolymers, but with some important differences. While the EO/PO/EO straight block copolymers tend to be better emulsifiers and dispersants and cover a broader range of molecular weights, the reverse block copolymers have lower foaming, greater defoaming, and reduced gelling tendencies. Additionally, reverse block copolymers are terminated by secondary hydroxyl groups, which have lower reactivity and acidity than the primary hydroxyl groups which terminate the EO/PO/EO straight block copolymers.

Tetra-functional block copolymers and their reverse counterparts, which are derived from the sequential addition of propylene oxide and ethylene oxide to ethylene diamine are also useful in the compositions of this disclosure.

Alkyl polyglycosides are understood to be the reaction products of sugars and fatty alcohols, suitable sugar components being the aldoses and ketoses such as glucose, fructose, mannose, galactose, talose, gulose, allose, altrose, idose, arabinose, xylose, lyxose, lactose, sucrose, maltose, maltotriose, cellobiose, mellobiase, and ribose, which are referred to hereinafter as glycoses. Particularly preferred alkyl polyglycosides are alkyl glucosides by virtue of the ready availability of glucose. In its broadest sense, the term “alkyl” in alkyl polyglycoside is intended to encompass the residue of an aliphatic alcohol, preferably a fatty alcohol, obtainable from natural fats, i.e., saturated and unsaturated residues and also mixtures thereof, including those having different chain lengths. The terms alkyl oligoglycoside, alkyl polyglycoside, alkyl oligosaccharide and alkyl polysaccharide apply to alkylated glycoses of the type in which one alkyl radical in the form of the acetal is attached to more than one glycose residue, i.e., to a polysaccharide or oligosaccharide residue; these terms are generally regarded as synonymous with one another. Accordingly, alkyl monoglycoside is the acetal of a monosaccharide. Since the reaction products of the sugars and the fatty alcohols are generally mixtures, the term alkyl polyglycoside is intended to encompass both alkyl monoglycosides and also alkyl poly(oligo)glycosides.

Optionally, there can be a polyoxyalkylene chain joining the alcohol moiety and the saccharide moiety. The preferred alkoxide is ethylene oxide.

The higher alkyl polyglycosides express surfactant properties. By “higher alkyl polyglycoside” is meant a glycoside having an alkyl substituent that averages more than four carbon atoms in size.

The lipophilic groups in the alkyl polyglycosides are derived from alcohols, preferably monohydric for compatibilizer applications and should contain from 4 to 22, preferably 7 to 16 carbon atoms. While the preferred groups are saturated aliphatic or alkyl, there may be present some unsaturated aliphatic hydrocarbon groups. Thus, the preferred groups are derived from the fatty alcohols derived from the naturally-occurring fats and oils, such as octyl, decyl, dodecyl, tetradecyl, hexadecyl, octadecyl, oleyl and linoleyl, but groups may be derived from synthetically produced Ziegler alcohols or oxo alcohols containing 9, 10, 11, 12, 13, 14 or 15 carbon atoms. The alcohols of naturally-occurring fatty acids, typically containing an even number of carbon atoms and mixtures of alcohols, are commercially available such as mixtures of C₈ and C₁₀, C₁₂ and C₁₄, and the like. Synthetically-produced alcohols, for example those produced by an oxo process, contain both an odd and even number of carbon atoms such as the C₉, C₁₀, C₁₁ mixtures.

From their production, the alkyl polyglycosides may contain small quantities, for example 1 to 2%, of unreacted long-chain alcohol which does not adversely affect the properties of the surfactant systems produced with them.

First coating can also include a binder. Binders that can be used in first coating 30 include, but are not limited to, polyvinyl alcohol (PVA), polymers and copolymers of polyvinyl acetate, vinylidene chloride, methyl cellulose, acrylic, cellulose, polyvinylpyrrolidone, polysaccharide, or any combinations thereof. Optionally, first coating 30 can include activated carbon. In one embodiment, the binder is an aqueous solution of between about 5% to about 10% polyvinyl alcohol based on weight of the seed.

Second coating 40 can be composed of any of the following, but not limited to, ddiatomaceous earth (DE), Lime, Clay, and/or a binder. Diatomaceous earth is a naturally occurring, soft, siliceous sedimentary rock, which can be crumbled into a fine powder particle sizes ranging from 3 μm to 1 mm, and which contains 70 to 95% silica, 2 to 4% alumina and 0.5 to 2% iron oxide. Lime can be substituted for with any calcium-containing inorganic material in which carbonates, oxides and hydroxides are present in large quantities. Binders that can be used in second coating 40 include, but are not limited to, polyvinyl alcohol (PVA), polymers and copolymers of polyvinyl acetate, vinylidene chloride, methyl cellulose, acrylic, cellulose, polyvinylpyrrolidone, polysaccharide, or any combinations thereof.

Third coating 50 can also be a surfactant. The surfactant of the first coating 30 and third coating 50 can be the same composition or can be a different composition. Third coating 50 can also include a binder like in second coating 40.

Seed composition 10, when subjected to drought conditions, water deficit, or deficit irrigation, or both, can exhibit similar seed germination, seed emergence, and seedling growth as if planted and grown under non-drought conditions or exposed to normal irrigation. Additionally, seed composition 10 can exhibit acceptable performance where an uncoated seed would otherwise fail.

A seed or plurality of seeds according to the present disclosure can be coated using a seed coater with centrifugal force as the functioning principle. A spinning drum with positive air pressure from below can be used to push seeds to an outer wall. A spinning dish is centrally located, and distributes the coating or treatment evenly onto the seeds. An example of such a seed coater is the RP14DB rotostat seed coater (BraceWorks Automation and Electric, Lloydminster, Saskatchewan, Canada). As used herein, materials coated onto the seed are based on percentage of total seed weight. This allows for the coating to work regardless of total seed volume.

In one preferred embodiment, outer layer 22 is coated with 5% weight of product to total seed weight (w/w) of surfactant, an 8% solution of polyvinyl alcohol (PVA) (Selvol 205), and a w/w activated carbon, thus yielding first coating 30. Next a w/w of either diatomaceous earth or lime is applied onto outer layer 32, thus yielding second coating 40. Third, a surfactant is applied onto outer layer 42, thus yielding third coating 50.

In other preferred embodiments, a bioeffecaciously effective amount of the surfactant can be about 10%, 20%, 30%, or 60% weight of product to total seed weight (w/w), or any amount between about 0.5% and about 80%, preferably about 0.5% and about 25%, most preferably between about 5% and about 20%.

The weight percentage of surfactant applied in first coating 30 and third coating 50 can be the same or optionally be different.

Seed composition 10 exhibits enhanced germination, emergence, and seedling growth and vigor in wettable soils and water repellent soils.

Without wishing to be bound by a particular theory, it is believed that, imbibition by a bare seed under water deficit is enhanced due to more ready access to available water. Seeds have many structures and organic compounds associated with their surfaces to protect them form to readily accepting water at undesirable times. A surfactant treatment on a bare seed, i.e. seed composition 10, may act as a vehicle for hydrating various hydrophobic components of the seed (increasing the permeability of the seed) and the surrounding soil, enabling the available water to access the embryo. Once germination is initiated, the surfactant may improve access to available water.

It is further believed that seed composition 10 facilitates water transport or movement from the soil to the seed. Seed composition 10 facilitates water uptake by the seed. There is increased water movement around the seed and root zone. Because there is faster germination, there is faster stand establishment and less water is needed. Crop production costs may decrease, and yields may increase.

Under water deficit, seed composition 10 emerges between about 0.5 and about 3 or more days earlier than an uncoated seed.

Under water deficit, seed composition 10 has an increased seedling count from emergence through 14 days that is better than the untreated. At 5 days after seeding, seed composition 10 has increased seedling count that is more than between about 1.5 times to about 3 times better than the untreated. At 7 days after seeding, seed composition 10 has increased seedling count that is more than between about 1.1 times to about 3 times better than the untreated.

At 9 days after seeding, seed composition 10 has increased seedling count that is more than between about 1.5 times and about 22 times better than the untreated. At 14 days after seeding, seed composition 10 has increased seedling count that is more than between about 1.5 times and about 3 better than the untreated.

Under severe water deficit, seed composition 10 has an increased seedling count from emergence through 14 days that is better than the untreated. At 9 days after seeding, seed composition 10 has increased seedling count that is more than between about 6 and about 22 times better than the untreated. At 14 days after seeding, seed composition 10 has increased seedling count that is more than between about 1.5 and about 3 times better than the untreated. As water deficit increases, response is not negatively affected.

Under water deficits, seed composition 10 has vigor ratings that are greater than the untreated. At 14 days after seeding, seed composition 10 has a vigor rating that is between about 5% and about 40% or greater than the untreated. At 21 days after seeding, seed composition 10 has a vigor rating that is between about 10% and about 180% or greater than the untreated. At 28 days after seeding, seed composition 10 has a vigor rating that is between about 5% and about 165% or greater than the untreated.

Under severe water deficits, seed composition 10 has vigor ratings that are greater than the untreated. At 9 days after seeding, seed composition 10 has a vigor rating that is between about 15% and about 45% or greater than the untreated. At 14 days after seeding, seed composition 10 has a vigor rating that is between about 5% and about 40% or greater than the untreated. At 21 days after seeding, seed composition 10 has a vigor rating that is between about 12% and about 53% or greater than the untreated. At 28 days after seeding, seed composition 10 has a vigor rating that is between about 5% and about 53% or greater than the untreated.

Under water deficits, seed composition 10 has an increased percent cover ratings than the untreated. At 21 days after seeding, seed composition 10 has a percent cover rating that is between about 2 and about 5 times or greater than the untreated. At 28 days after seeding, seed composition 10 has a percent cover rating that is between about 4 and about 10 times or greater than the untreated.

Under severe water deficits, seed composition 10 has an increased percent cover ratings greater than the untreated. At 21 days after seeding, seed composition 10 has a percent cover rating that is between about 1.3 and about 8 times or greater than the untreated. At 28 days after seeding, seed composition 10 has a percent cover rating that is between about 8 and about 16 times or greater than the untreated.

Under water deficits, seed composition 10 can reach 3 inch shoot heights, (a measure of shoot growth) more than between about 3 and about 6 days faster than the untreated.

Under water deficits, seed composition 10 results in more than between about 1.3 and about 3 times more biomass than the untreated.

As discussed previously, an adverse soil condition also includes salinity. Different crops have different tolerance levels to saline irrigation water. The typical range for most crop salinity tolerance is between about 0.5 ds/m and about 12 ds/m. These numbers are highly dependent on the percent yield of the crop; i.e. the higher the ds/m the lower the yield. The salinity of tap water is approximately 0.5 ds/m while the salinity of sea water is approximately 50 ds/m. As water resources diminish and poor water quality becomes the norm for irrigating agriculture and landscape markets, the salinity of irrigation water is expected to increase significantly. Therefore, salinity tolerance of crops must increase.

For example, the salinity of irrigation water if a grower wants to achieve 100% yield of perennial ryegrass (Lolium perenne), bermudagrass (Cynodon dactylon) and tall fescue (Festuca arundinacea) is 5.6 ds/m, 6.9 ds/m and 3.9 ds/m, respectively. Crops such as corn (Zea mays), potato (Solanum tuberosum) and rice (Oryza sativa) have salinity tolerance levels of 1.7 ds/m, 1.7 ds/m, and 3.0 ds/m. Irrigation water with higher salinity levels may cause leaf and root burn, reducing photosynthesis and growth which will severely inhibit yield. Seeds are particularly sensitive to saline conditions. Significant reductions in crop yield are due to the initial lack of germination and establishment of seedlings irrigated with high saline irrigation water. The present disclosure provides a seed coating that achieves the unexpected result of increasing the salinity tolerance of plants.

While high saline irrigation water is not optimal, it is the deleterious effects of high saline water on fine texture soil that poses a real problem to crop growth and establishment. If high saline water is applied to fine textured soils such as clay, the salt ions will deflocculate (cause the soil structure to collapse), preventing water and nutrient movement into and through the soil profile. Once the soil structure has collapsed, it is very difficult to correct. Only excessive amounts of a calcium source, such as gypsum, can improve the structure but the amount time necessary to flocculate the soils again may be years. The reduced ability of the deflocculated soils to retain water and nutrients leads to reduced seedling germination, establishment, and overall yield.

Under saline and extreme saline conditions, seed composition 10 germinates and emerges between about 1.5 and about 3 days faster than an uncoated seed.

Under saline and extreme saline conditions, seed composition 10 has an increased seedling count from emergence through 14 days that is better than the untreated. Seed composition 10 has increased seedling count that is more than between about 1.5 times to about 3 times better than the untreated.

Under saline and extreme saline conditions, seed composition 10 has an increased percent cover ratings than the untreated. Seed composition 10 has a percent cover rating that is between about 2 and about 10 times or greater than the untreated. Experimental data suggests that this occurs at half the seeding rate as the untreated seed (See Table 25).

Under saline and severe saline conditions, seed composition 10 has an increased percent cover ratings greater than the untreated. Seed composition 10 has a percent cover rating that is between about 1.5 and about 3 times or greater than the untreated.

Seed composition 10, when planted in high-saline soil, or when exposed to high saline water, or both, exhibits similar seed germination, seed emergence, and seedling growth as if planted in uncompromised soil or exposed to uncompromised water.

Provided also is a system for improving germination rate, emergence, and growth of a seed under adverse conditions, including, but not limited to water deficit conditions, deficit irrigation, saline soil, and saline water. The system has soil media, a seed, and a non-ionic surfactant coated to the seed.

The non-ionic surfactant can be coated to the seed by a binder.

The soil media can be wettable or water repellent/hydrophobic. The soil can be under deficit irrigation, subject to drought or water deficit conditions, subject to saline water, have a high salt content, combinations of the foregoing, and the like. Alternatively, the soil media can be a combination of wettable and water repellent/hydrophobic.

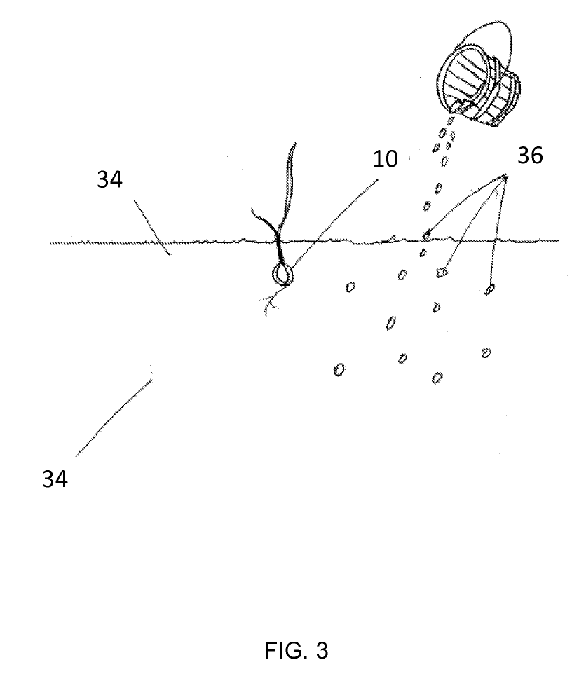

Referring now to FIG. 3, the non-ionic surfactant 36 can also be applied to the soil media 34, alone, or combination with seed composition 10. A solution that includes the surfactant can be prepared for direct application to the soil. Solution of surfactant can be applied at 90 ml/m² up to 380 ml/m². The non-ionic surfactant facilitates water transport from the soil media to the seed and facilitates water uptake by the seed. The non-ionic surfactant comprises between about 0.5% to about 20% by weight of the seed. The non-ionic surfactant can be the same as that of first coating 30.

The binder is an aqueous solution of between about 5% to about 10% polyvinyl alcohol based on weight of the seed and can be one selected from the group consisting of: polyvinyl alcohol, polymers and copolymers of polyvinyl acetate, vinylidene chloride, methyl cellulose, acrylic, cellulose, polyvinylpyrrolidone, polysaccharide, and any combinations thereof.

In some embodiments, the seed and the non-ionic surfactant coated to the seed form a first layer. A second layer can be disposed on the first layer. The second layer can contain diatomaceous earth, clay, a binder, and lime. A third layer composed of a surfactant like that of first coating 30 can be disposed on the second layer.

The seed and the non-ionic surfactant of the system exhibit enhanced germination rates, enhanced growth rates, enhanced establishment rates, and enhanced emergence rates, among others, in wettable soil under severe water deficit conditions (50% evapotranspiration (ETos) irrigation replenishment).

The seed of the system is selected from the group consisting: of grass seed (for example, seashore paspalum, perennial ryegrass, annual ryegrass, tall fescue, Kentucky bluegrass, bermudagrass, buffalograss), fruit seed, plant seed, vegetable seed, corn seed, soybean, sorghum, flower seed, wheat seed, and the like.

A method for improving germination rate of a seed is also provided. An agricultural composition including a non-ionic surfactant and a binder is prepared. An uncoated seed is selected. The uncoated seed is coated with a bioeffecaciously effective amount of the agricultural composition thus yielding a coated seed. The seed is placed in soil.

The soil can be a wettable medium or a water repellent/hydrophobic medium. The soil can be under drought conditions or under a water deficit or deficit irrigation.

The coated seed according to the method has an improved germination rate, emergence rate, and overall establishment compared to the uncoated seed.

The agricultural coating can also include a binder such as polyvinyl alcohol, polymers and copolymers of polyvinyl acetate, vinylidene chloride, methyl cellulose, acrylic, cellulose, polyvinylpyrrolidone, polysaccharide, and any combinations thereof.

The surfactant can be one such as in first coating 30. A second coating can be applied to the coated seed that includes diatomaceous earth, clay, a binder, and/or lime. A third coating that includes a surfactant like that of first coating 30 can also be applied to the second coating.

The resultant coated seed exhibits enhanced germination rates in wettable soil under 50% evapotranspiration (ETos) irrigation replenishment, exhibits enhanced growth rates in wettable soil under 50% evapotranspiration (ETos) irrigation replenishment, exhibits enhanced establishment in wettable soil under 50% evapotranspiration (ETos) irrigation replenishment, exhibits enhanced emergence rates in wettable soil under 50% evapotranspiration (ETos) irrigation replenishment, and the developing seedling fixes more carbon than the uncoated seed in the same time period.

Like the system, the uncoated seed used in the method can be seashore paspalum, perennial ryegrass, tall fescue, Kentucky bluegrass, fruit seed, grass seed, plant seed, vegetable seed, corn seed, flower seed, and wheat seed.

Surprisingly, it has also been found that an agricultural coating that improves the germination rate, emergence, rate, and overall establishment is comprised of at least one of the following: an alkyl ether of methyl oxirane-oxirane copolymer, ethylene oxide-propylene oxide block copolymer, C₈-₁₀ Alkylpolyglucosides, Polyoxyethylene-Polyoxypropylene Block Co-polymer, C₁-C₄ alkyl ether of ethylene oxide-propylene oxide block copolymer, alkyl polyglycoside, a copolymer produced by the interaction of about 9 moles of ethylene oxide with about 2 moles of propylene oxide end-blocked with dimethyl ether (PEG/PPG-9/2 dimethyl ether), a copolymer produced by the interaction of about 3 moles of ethylene oxide with about 6 moles of propylene oxide end-blocked with dimethyl ether (PEG/PPG-3/6 dimethyl ether), a copolymer produced by the interaction of about 14 moles of ethylene oxide with about 7 moles of propylene oxide end-blocked with dimethyl ether (PEG/PPG-14/7 dimethyl ether), methyloxirane polymer with oxirane and dimethyl ether, alkoxylated polyol, and glucoether surfactants. The agricultural composition can also be various combinations of the aforementioned surfactants.

The Experimental section of this disclosure provides test data for a seed composition for species of grass seed including, but not limited to, seashore paspalum, perennial ryegrass, tall fescue, and Kentucky bluegrass. However, it is contemplated that similar enhancements would be provided by a seed composition of any variety, including, but not limited to, fruit seed, grass seed, plant seed, vegetable seed, corn seed, flower seed, and wheat seed, soybean seed, sorghum seed, cotton seed, and the like. The surfactants used in the testing were ASET-4001 and ASET-4002 (Aquatrols® Corporation of America, Paulsboro, N.J., U.S.A.).

### Experimental

ASET-4001 and ASET-4002 were tested in four geographic locations during 2013: New Mexico State University, Las Cruces, N. Mex.; The Pennsylvania State University, Berks Campus, Reading, Pa.; and the University of Florida, Fort Lauderdale Fla. Studies ranged from micro-scale (greenhouse) to meso-scale (in-field plot research, 12 ft²). Grass species included in the analysis were: perennial ryegrass (Lolium perenne), tall fescue (Fescuta arundinacea) and Kentucky bluegrass (Poa pratensis). Treatments varied slightly from study to study, encompassing water repellant soils, wettable soils, deficit irrigation, soil salinity, and surfactant seed coating thickness. Basic turfgrass measurements included: germination counts, percent cover, seedling vigor, days to reach 3 inch height, and oven dry leaf clippings. A detailed description of the methodologies used at each location follows. For all studies, percent cover was visually determined on a scale of 1-100%.

The first set of studies was directed to adverse soil conditions relating to water deficits from drought or deficit irrigation. The second set of studies was directed to adverse soil conditions related to salinity. The first set of studies follows.

The studies demonstrate that ASET-4001 does improve germination, emergence, vigor and percent cover of turfgrass under water deficit” conditions; particularly water deficit, and in wettable and/or water repellent/hydrophobic soils. Research presented was conducted at three locations (The Pennsylvania State University, New Mexico State University, and The University of Florida). Three types of grasses were evaluated (tall fescue, Kentucky bluegrass and perennial ryegrass) under greenhouse and field conditions.

Under field conditions, ASET coatings at the 10% and 20% coating rate resulted in improved field emergence for tall fescue. Percent cover of Kentucky bluegrass, tall fescue and perennial ryegrass in field conditions and under deficit irrigation of 50% ETos, was considerably enhanced by both ASET-4001 at 10% and 20% coating rates.

Greenhouse experiments with perennial ryegrass and Kentucky bluegrass resulted in improved percent cover under deficit and severe deficit irrigation when seeds were coated with ASET-4001 at the 5% and 20% coating rate. At the Pennsylvania location, seedling count and seedling vigor results indicate ASET-4001, particularly at the 20% coating rate, provided benefit to both Kentucky bluegrass and perennial ryegrass by enhancing emergence and health under deficit and severe deficit irrigation. At the Florida location, perennial ryegrass coated with ASET-4001 improved percent cover in wettable and water repellent soils under extreme conditions.

Seeds coated with ASET-4001 enhanced seedling emergence, cover, and health when planted in three soil types. ASET-4001 seed coating also improved seedling performance under severe water deficits in both wettable and water repellent soils. The benefit to growers is the ability to plant seeds under stressful environmental conditions and still maintain or increase yields.

Field studies suggest ASET-4002 coatings at 10% tended to improve emergence for tall fescue. Percent cover enhancements were most notable at the New Mexico site, where significantly greater turf coverage was observed for seedlings treated with ASET-4002 10% and under deficit irrigation (50% of water requirement met). Perennial ryegrass responded most positively with 2 times the cover in ASET-4002 treated plots compared to the control.

Greenhouse studies assessing perennial ryegrass and Kentucky bluegrass were conducted in Pennsylvania and Florida. In most cases, ASET-4002 20% improved seedling emergence, counts, vigor and percent cover under water deficit and full irrigation scenarios at both locations. Perennial ryegrass response to ASET-4002 at 20% exhibited positive trends s but not showing improvements in percent cover or days to reach a 3 inch height. Under severe water deficits, ASET-4002 20% coatings resulted in faster emergence, higher seedling counts, improved seedling vigor, and greater turf coverage when compared to the untreated control for Kentucky Bluegrass seeds. Perennial ryegrass expressed positive trends in seedling vigor only at the ASET-4002 5% rate.

A deficit irrigation field study on a wettable soil was initiated in September 2013 and conducted through December 2013 at New Mexico State University in Las Cruces, N. Mex. The soil at the site consisted of a wettable sandy loam, a sandy, skeletal, mixed, thermic Typic Torriorthent, an entisol typical for arid regions. The study was established as a completely randomized block (irrigation) with 3 treatments replicated 3 times for each of the following grass species: perennial ryegrass (“LS2300”), and tall fescue. Treatments consisted of: a) control (no seed coating), b) ASET-4001 seed coating at the 10% rate or C) at the 20% rate. The dimensions of the individual plots were 1.5 m×1.2 m. The same was repeated but with ASET-4002 instead of ASET-4001.

Before seeding, Milorganite (5-2-0) organic fertilizer was incorporated into the soil at a rate of 5 g N/m⁻². Treated and untreated seeds were planted on Sep. 6, 2013, based on the weight of uncoated seeds at rates of 40, 30, or 15 g m⁻² for tall fescue, and perennial ryegrass, respectively. Immediately after seeding, plots were rolled to ensure optimal seed soil contact. Plots were fertilized again on October 16, October 30, and November 15 with 2.5 g m⁻² KNO₃ and 2.5 g m⁻² of P₂O₅ m².

Irrigation was based on 100% ETos and 50% ETos replacement. ETos is reference evapotranspiration, the amount of water lost from plant and soil surfaces via evaporation and the amount of water plants lose from their leaves via transpiration. ETos fluctuates daily and is based on air temperature, wind speed, humidity, sunlight, and air. Irrigation was replaced based on 100% ETos (100% lost from the plant and soil was replaced via irrigation) and 50% ETos (50% of water lost from the plant and soil was replaced via irrigation, a means of applying a drought or water deficit). Water savings will be significant if turfgrass stands are able to withstand only 50% ETos replacement and still yield similar results as turfgrass subjected to 100% ETos. For this study, irrigation was applied twice per day, during the morning and during mid-afternoon until November 25. From November 25 until the end of the research period irrigation was applied only in the morning. Irrigation audits conducted prior to the study provided data necessary to calculate irrigation systems run times. Irrigation run times were calculated every Monday morning based on the previous week's ET_{OS} and plots received the total daily equivalent of 1/7 of the total weekly ET_{OS}. Climate data to calculate ET_{OS} were collected at a weather station in close proximity to the research site. Irrigation was withheld for 24 hours before soil moisture readings.

Treatments were evaluated based on emergence and percent cover. Emergence was evaluated on a 0-3 scale with 0 having no emergence and 3 having emergence across the entire plot on 8 days after seeding (DAS) and 17 DAS. Percent cover was measured beginning on 39 DAS. A photograph of each plot was taken weekly [October 24 (48 DAS), October 30 (54 DAS), November 6 (61 DAS), November 12 (67 DAS), November 19 (74 DAS) and on December 5 (DAS 90) to determine total grass coverage. A 92 cm (length)×61 cm (width)×61 cm (height) metal box equipped on the inside with four 9 W lamps was used to provide equal and uniform lighting conditions for all the photographs taken. Turf coverage was determined using SigmaScan Pro 5 software (SPSS, 1998). Collected data was then averaged across seven sampling dates.

Statistically significant increases in field emergence were observed in tall fescue, with the greatest response observed in the 20% ASET-4001 treatment.

Table la below shows field emergence based on a 0-3 scale, where 0 (no emergence) and 3 (emergence across entire plot).

| | |
|---|---|
| Tall Fescue | Perennial Ryegrass* |

| Treatment | Avg.* | 100% ETo | 50% ETo |
|---|---|---|---|
| ASET-4001 10% | 1.7 | 1.3 | 1.8 |
| ASET-4001 20% | 2.4 | 2.0 | 2.3 |
| Untreated | 0.8 | 2.7 | 1.3 |

*Values for tall fescue are averaged over 2 sampling dates and 2 irrigation levels. Values for perennial ryegrass are listed separately for 100% ET_{OS} and 50% ET_{OS} and are averaged over 2 sampling dates.

Seedling emergence of tall fescue was numerically better for ASET-4002 10% coated seed when compared to the control treatment. Under deficit irrigation (50̂% ETo), seedling emergence was greater for the coated seed.

Table 1b below shows field emergence based on a 0-3 scale, where 0 (no emergence) and 3 (emergence across entire plot).

| | |
|---|---|
| Tall Fescue | Perennial Ryegrass* |

| Treatment | Avg.* | 100% ETo | 50% ETo |
|---|---|---|---|
| ASET-4002 10% | 1.1 | 2.5 | 1.3 |
| Untreated | 0.8 | 2.7 | 1.3 |

*Values for tall fescue are averaged over 2 sampling dates and 2 irrigation levels. Values for perennial ryegrass are listed separately for 100% ET_{OS} and 50% ET_{OS} and are averaged over 2 sampling dates.

Under full irrigation (100% ET replacement), increases in percent cover were observed in any of the three test varieties treated with ASET-4001. Under water deficit (50% ET replacement), differences in percent cover were observed in both perennial ryegrass and tall fescue. For all seed types, the ASET-4001 treatment at 10% and 20% resulted in numerically better establishment of seed under deficit irrigation conditions. It should be noted that establishment under deficit irrigation was similar at both rates of ASET-4001, with the exception of the tall fescue where the 10% rate of ASET-4001 significantly improved establishment compared to the ASET-4001 20% rate. ASET-4001 technology improved the coated seed's performance under severe water deficit conditions despite varietal response to the lack of water. ASET-4001 treatment influenced turf performance under water deficit conditions in a wettable soil.

Table 2a below shows percent cover of coated and uncoated, perennial ryegrass, and tall fescue at irrigation levels of 100% and 50% ETOS. Data are averaged over 7 sampling dates.

| | | |
|---|---|---|
| Coating | 100% ET_{OS} | 50% ET_{OS} |

Perennial ryegrass

| | | |
|---|---|---|
| ASET-4001 10% | 76.2 | 52.7 |
| ASET-4001 20% | 69.3 | 54.1 |
| Control | 79.8 | 48.8 |

Tall fescue

| | | |
|---|---|---|
| ASET-4001 10% | 74.4 | 68.8 |
| ASET-4001 20% | 78.4 | 58.5 |
| Control | 80.2 | 29.4 |

When water needs were fully replaced at 100% ET, surfactant seed coating (ASET-4002 10%) had no effect on percent cover in perennial ryegrass or tall fescue. However, when water was reduced by 50%, ASET-4002 seed coating significantly improved percent cover for all grass species tested. For perennial ryegrass, ASET-4002 treatment increased percent cover 1.5-fold, and in tall fescue, ASET-4002 treatment increased percent cover 2-fold versus the control. ASET-4002 under water deficit preserved percent cover in perennial ryegrass. Under water deficit (50% ET), percent cover was 72% and statistically equivalent to the 79% observed under full irrigation. Similar trends in improved percent cover were observed for tall fescue (76% under full irrigation and 58% under deficit irrigation). Results demonstrate that ASET-4002 treatments may improve seed performance under reduced irrigation management strategies particularly when growing in newly seed turf in water limiting environments.

Table 2b below shows percent cover of coated and uncoated perennial ryegrass and tall fescue at irrigation levels of 100% and 50% ETOS. Data are averaged over 7 sampling dates.

| | | |
|---|---|---|
| Coating | 100% ET_{OS} | 50% ET_{OS} |

Perennial ryegrass

| | | |
|---|---|---|
| ASET-4002 10% | 79.0 | 72.1 |
| Control | 79.8 | 48.8 |

Tall fescue

| | | |
|---|---|---|
| ASET-4002 10% | 76.0 | 57.9 |
| Control | 80.2 | 29.4 |

A deficit irrigation trial was conducted on a wettable soil at The Pennsylvania State University-Reading, Pa. Greenhouse studies were conducted evaluating: Kentucky bluegrass and perennial ryegrass performance under water deficit with and without an ASET-4001 seed coating at the 5% and 20% loading rate. The study was arranged as a randomized complete block design, with five replications of each treatment. Greenhouse pots were filled with a wettable silt loam soil which is the most common soil type for most home lawns across the United States. Kentucky bluegrass and perennial ryegrass were seeded at 15 g N/m⁻² and 50 g N/m⁻². Seeds were placed on the soil, pressed, covered with more of the same soil and then immediately received 0.6 cm of water. Deficit irrigation was maintained at 2 cm water per week. No starter fertilizer was used. The same was repeated using ASET-4002 in place of ASET-4001.

Measurement parameters consisted of seedling emergence, percent cover, seedling vigor, days to 3-inch height, and over-dry leaf clippings. Seedling emergence was conducted by counting shoots, until 20 shoots were evident. Thereafter, percent cover was used to evaluate emergence and rated visually on a scale of 0-100%. Seedling vigor was assessed as turf quality using a 1-9 visual rating where 1=no emergence and 10=healthy turf. Oven dry leaf clipping weights were assessed by removing entire leaf biomass (at the top of turf/soil interface) with scissors, placing in an envelope and oven dried at 105° C. for 72 hours. Dried clippings were then weighed. Days to 3 inch height were determined as the number of days for >50% of seedlings to reach 3 inch height.

Under water deficit (2 cm irrigation/week), seed emergence was faster enabling the root to access a source of water resulting in better stand establishment. Both ASET treatments significantly improved speed of germination of Kentucky bluegrass (the lower the number the faster the germination).

Table 3a below shows Days to First Emergence for Kentucky bluegrass and Perennial ryegrass. The lower the number, the faster the germination.

Days to First Emergence

| Treatment | Kentucky bluegrass | Perennial Ryegrass |
|---|---|---|
| ASET-4001 5% | 8.2 | 5.0 |
| ASET-4001 20% | 8.2 | 4.6 |
| Untreated | 8.8 | 4.4 |
| LSD (P = 0.05) | 0.45 | 0.83 |

ASET-4002 5% and ASET-4002 20% significantly improved perennial ryegrass and Kentucky bluegrass seedling emergence when compared to the control treatment. There was no difference between the two seed coatings. Under deficit irrigation, ASET-4002 technology reduced the number of days for the seedling to emerge, increasing the seedling survivability under water deficit stress.

Table 3b below shows Days to First Emergence for Kentucky bluegrass and perennial ryegrass. The lower the number, the faster the germination.

Days to First Emergence

| Treatment | Kentucky bluegrass | Perennial Ryegrass |
|---|---|---|
| ASET-4002 5% | 8.2 | 4.4 |
| ASET-4002 20% | 8.0 | 4.8 |
| Untreated | 8.8 | 5.0 |
| LSD (P = 0.05) | 0.45 | 0.83 |

Seedling counts for Kentucky bluegrass at 8 and 9 days after seeding (DAS) were significantly higher for ASET-4001 5% and ASET-4001 20% coated seeds compared to the control. Additionally, at 14 DAS, seeds coated with ASET-4001 20% exhibited significantly higher seedling counts, doubling the number of Kentucky bluegrass seedlings that emerged compared to the untreated control. By the end of the trial, after two weeks of deficit irrigation in a wettable soil, seedling counts were higher with the ASET-4001 treatment compared to the uncoated seeds.

Table 4a below shows Kentucky bluegrass seedling counts. Counts were recorded until >20 seedlings emerged.

| | Seedling Counts Days After Seeding (DAS) | | | | | |
|---|---|---|---|---|---|---|
| Treatments | 0 DAS | 3 DAS | 7 DAS | 8 DAS | 9 DAS | 14 DAS |
| Untreated | 0 | 0 | 0 | 0.4 | 5.6 | 18.6 |
| ASET-4001 | 0 | 0 | 0 | 4.8 | 10.6 | 24.6 |
| 5% | | | | | | |
| ASET-4001 | 0 | 0 | 0 | 5.8 | 10.2 | 37.6 |
| 20% | | | | | | |
| LSD | 0 | 0 | 0 | 3.98 | 3.56 | 6.14 |
| (P = 0.05) | | | | | | |

All Kentucky bluegrass seedling counts started at 8 DAS. On every collection date, ASET technology significantly enhanced seedling emergence when compared to the control treatment. At 9 DAS and 14 DAS, ASET-4002 20% significantly improved seedling emergence when compared to ASET-4002 5%. Under deficit irrigation, ASET-4002 technology improved seedling counts, therefore seedling germination, greatly enhancing seedling survivability. ASET-4002 20% doubled the number of Kentucky bluegrass seedling counts.

Table 4b below shows Kentucky bluegrass seedling counts. Counts were recorded until >20 seedlings emerged.

| | Seedling Counts Days After Seeding (DAS) | | | | | |
|---|---|---|---|---|---|---|
| Treatments | 0 DAS | 3 DAS | 7 DAS | 8 DAS | 9 DAS | 14 DAS |
| Untreated | 0 | 0 | 0 | 0.4 | 5.6 | 18.6 |
| ASET-4002 | 0 | 0 | 0 | 6.2 | 11.8 | 31.8 |
| 5% | | | | | | |
| ASET-4002 | 0 | 0 | 0 | 8.0 | 16.6 | 38.6 |
| 20% | | | | | | |
| LSD | 0 | 0 | 0 | 3.98 | 3.56 | 6.14 |
| (P = 0.05) | | | | | | |

Perennial ryegrass seed emerged at 4 DAS. The ASET-4001 20% treatment showed a trend towards improved emergence on every data collection date when compared to the untreated seed.

Table 5a below shows perennial ryegrass seedling counts. Counts were recorded until >20 seedlings emerged.

| | Seedling Counts Days After Seeding (DAS) | | | | |
|---|---|---|---|---|---|
| Treatments | 0 DAS | 3 DAS | 4 DAS | 5 DAS | 7 DAS |
| Untreated | 0 | 0 | 0 | 2.6 | 27.4 |
| ASET-4001 5% | 0 | 0 | 0.8 | 3.2 | 23.8 |
| ASET-4001 20% | 0 | 0 | 3.0 | 7.0 | 30.2 |
| LSD (P = 0.05) | 0 | 0 | 0 | 0 | 0 |

Perennial ryegrass seeds coated with ASET technology emerged earlier than uncoated seeds. Seeds first emerged at 3 DAS when coated with ASET-4002 5% coating and 4 DAS when coated with ASET-4002 20% coating. Untreated seeds emerged 5 DAS. Emergence was accelerated by ASET treatment. At 7 DAS all treatments exhibited greater than 20 seedlings.

Table 5b below shows perennial ryegrass seedling counts. Counts were recorded until >20 seedlings emerged.

| | Seedling Counts Days After Seeding (DAS) | | | | |
|---|---|---|---|---|---|
| Treatments | 0 DAS | 3 DAS | 4 DAS | 5 DAS | 7 DAS |
| Untreated | 0 | 0 | 0 | 2.6 | 27.4 |
| ASET-4002 5% | 0 | 0.4 | 3.0 | 6.6 | 30.2 |
| ASET-4002 20% | 0 | 0 | 1.4 | 4.2 | 30.0 |
| LSD (P = 0.05) | 0 | 0 | 0 | 0 | 0 |

Significant reductions of applied water (water deficit) enhance wilt and tip burn of the turfgrass significantly impacting quality and stand establishment. When Kentucky bluegrass seedling vigor was evaluated, treatment differences were significant on 21 DAS and 28 DAS. ASET treatment improved seedling performance and viability under water deficit conditions in a wettable soil.

Table 6a below shows Effects of ASET-4001 on Kentucky bluegrass seedling vigor.

| | Seedling Vigor - Days After Seeding (DAS) | | | | | | | |
|---|---|---|---|---|---|---|---|---|
| Treatment | 1 DAS | 3 DAS | 7 DAS | 8 DAS | 9 DAS | 14 DAS | 21 DAS | 28 DAS |
| Untreated | 1.0 | 1.0 | 1.0 | 1.10 | 1.50 | 1.50 | 1.60 | 1.70 |
| ASET-4001 5% | 1.0 | 1.0 | 1.0 | 1.40 | 1.50 | 1.60 | 2.80 | 3.00 |
| ASET-4001 20% | 1.0 | 1.0 | 1.0 | 1.40 | 1.50 | 1.60 | 3.80 | 4.00 |
| LSD = P = 0.05 | 0 | 0 | 0 | .307 | .328 | .219 | .510 | .564 |

ASET-4002 20% significantly improved Kentucky bluegrass stand quality from 8 DAS until the end of the trial when compared to the uncoated seeds. ASET-4002 5% coating significantly enhanced seed quality on 8 DAS, 21 DAS and 28 DAS when compared to the control treatment. ASET 20% resulted in significantly better stand quality compared to ASET 5% on 8 DAS, 9 DAS, and 14 DAS. Beyond 14 DAS, no differences in seedling vigor associated with ASET coating were observed. By the end of the trial, seedling vigor was 2.5 times greater when seeds were coated with ASET-4002 compared to the control treatment. Under water deficit conditions, ASET technology improved the health and quality of Kentucky bluegrass sown in a wettable soil.

Table 6b below shows effects of ASET-4001 on Kentucky bluegrass seedling vigor.

| | Seedling Vigor - Days After Seeding (DAS) | | | | | | | |
|---|---|---|---|---|---|---|---|---|
| Treatment | 1 DAS | 3 DAS | 7 DAS | 8 DAS | 9 DAS | 14 DAS | 21 DAS | 28 DAS |
| Untreated | 1.0 | 1.0 | 1.0 | 1.10 | 1.50 | 1.50 | 1.60 | 1.70 |
| ASET-4002 5% | 1.0 | 1.0 | 1.0 | 1.50 | 1.80 | 1.50 | 4.40 | 4.40 |
| ASET-4002 20% | 1.0 | 1.0 | 1.0 | 1.90 | 2.30 | 2.10 | 4.50 | 4.50 |
| LSD = P = 0.05 | 0 | 0 | 0 | .307 | .328 | .219 | .510 | .564 |

ASET-4001 coated perennial ryegrass significantly improved the vigor of the seedlings when compared to the untreated control seeds on 21 DAS and 28 DAS. On 7 DAS and 14 DAS, the untreated seedlings had higher turfgrass vigor when compared to both treated seeds. However, after three and four weeks of limited water (water deficit), seedlings from the uncoated seeds were not able to maintain turfgrass quality. ASET treatment improved seedling performance and viability under water deficits in a wettable soil.

Table 7a below shows effects of ASET-4001 on perennial ryegrass seedling vigor.

| | Seedling Vigor - Days After Seeding (DAS) | | | | | | | |
|---|---|---|---|---|---|---|---|---|
| Treatment | 1 DAS | 3 DAS | 4 DAS | 5 DAS | 7 DAS | 14 DAS | 21 DAS | 28 DAS |
| Untreated | 1.0 | 1.0 | 1.20 | 1.90 | 2.70 | 5.90 | 6.30 | 6.60 |
| ASET-4001 5% | 1.0 | 1.0 | 1.40 | 2.00 | 2.10 | 3.80 | 7.00 | 7.40 |
| ASET-4001 20% | 1.0 | 1.0 | 1.60 | 2.10 | 2.30 | 5.20 | 7.50 | 7.90 |
| LSD = P = 0.05 | 0 | 0 | .770 | .293 | .359 | .747 | .457 | .460 |

Uncoated perennial ryegrass seed vigor was significantly higher than coated seed at 21 DAS. Prior to 21 DAS, no significant improvements in seedling vigor associated with ASET-4002 coatings were observed. Significant improvements in perennial ryegrass seedling vigor associated with surfactant coating were observed on 21 DAS and 28 DAS. At 21 DAS, both rates of ASET-4002 significantly improved the vigor of the seedlings compared to uncoated seeds. At 28 DAS, only ASET-4002 5% significantly enhanced vigor of the seedlings compared to the uncoated seed. Perennial ryegrass seed coated with ASET-4002 improved the performance of the grass after one month of water deficit conditions.

Table 7b below shows Effects of ASET-4002 on perennial ryegrass seedling vigor.

| | Seedling Vigor - Days After Seeding (DAS) | | | | | | | |
|---|---|---|---|---|---|---|---|---|
| Treatment | 1 DAS | 3 DAS | 4 DAS | 5 DAS | 7 DAS | 14 DAS | 21 DAS | 28 DAS |
| Untreated | 1.0 | 1.0 | 1.20 | 1.90 | 2.70 | 5.90 | 6.30 | 6.60 |
| ASET-4002 5% | 1.0 | 1.2 | 1.90 | 2.20 | 2.30 | 5.70 | 7.00 | 7.90 |
| ASET-4002 20% | 1.0 | 1.0 | 1.30 | 2.00 | 2.00 | 5.00 | 7.10 | 7.00 |
| LSD = P = 0.05 | 0 | 0 | .770 | .293 | .359 | .747 | .457 | .460 |

Percent cover was significantly greater under deficit irrigation when Kentucky bluegrass seeds were coated with ASET-4001 5% and ASET-4001 20% when compared to the control treatment. At 21 DAS and 28 DAS, ASET-4001 20% significantly improved turfgrass cover by 4 times and 9 times, respectively, when compared to the untreated control seeds. Four weeks after seeding, percent cover was improved by 5 times when seeds were coated with ASET-4001 5% compared to the untreated control. The control treatment appeared to stop growing 21 DAS and did not result in any greater percent cover thereafter. ASET treatment improved turf density in a wettable soil under water deficit conditions.

Table 8a below shows percent cover of Kentucky bluegrass under deficit irrigation.

Percent Cover - Days After Seeding (DAS)

| Treatment | 21 DAS | 28 DAS |
|---|---|---|
| Untreated | 2.2 | 2.2 |
| ASET-4001 5% | 5.0 | 10.0 |
| ASET-4001 20% | 8.0 | 18.0 |
| LSD (P = 0.05) | 2.87 | 4.21 |

Kentucky bluegrass cover was evaluated at 21 DAS and 28 DAS. On both dates, seeds treated with ASET technology significantly increased percent cover when compared to uncoated seeds. By 28 DAS, when compared to the control, cover was 7 times and 10 times greater with seeds treated with ASET-4002 5% and ASET 20%, respectively. Under deficit irrigation, ASET provided better germination, hence better coverage of Kentucky bluegrass.

Table 8b below shows percent cover of Kentucky bluegrass under deficit irrigation.

Percent Cover - Days After Seeding (DAS)

| Treatment | 21 DAS | 28 DAS |
|---|---|---|
| Untreated | 2.2 | 2.2 |
| ASET-4002 5% | 9.0 | 14.0 |
| ASET-4002 20% | 11.0 | 21.0 |
| LSD (P = 0.05) | 2.87 | 4.21 |

Percent cover of perennial ryegrass was not significantly improved by ASET-4001 technology. All treatments reached greater than 30% percent cover by the end of the trial.

Table 9a below shows percent cover of perennial ryegrass under deficit irrigation.

| | Percent Cover - Days After Seeding (DAS) | | | |
|---|---|---|---|---|
| Treatment | 7 DAS | 14 DAS | 21 DAS | 28 DAS |
| Untreated | 4.4 | 28.0 | 36.0 | 38.0 |
| ASET-4001 5% | 2.4 | 20.0 | 27.0 | 30.0 |
| ASET-4001 20% | 2.6 | 30.0 | 38.0 | 42.0 |
| LSD (P = 0.05) | 1.93 | 6.87 | 7.65 | 9.15 |

ASET-4002 5% did not significantly enhance percent cover of perennial ryegrass when compared to the control. Percent cover associated with ASET-4002 20% coated seeds was not significantly different from the control. However by 28 DAS, all treatments (including the control) exhibited similar percent cover of perennial ryegrass.

Table 9b below shows percent cover of perennial ryegrass under deficit irrigation.

| | Percent Cover - Days After Seeding (DAS) | | | |
|---|---|---|---|---|
| Treatment | 7 DAS | 14 DAS | 21 DAS | 28 DAS |
| Untreated | 4.4 | 28.0 | 36.0 | 38.0 |
| ASET-4002 5% | 2.4 | 21.0 | 28.0 | 33.0 |
| ASET-4002 20% | 2.2 | 28.0 | 36.0 | 38.0 |
| LSD (P = 0.05) | 1.93 | 6.87 | 7.65 | 9.15 |

The number of days for Kentucky bluegrass and perennial ryegrass to reach a 3″ height is a good indicator of plant health and overall seed establishment. ASET-4001 20% significantly reduced the number of days for Kentucky bluegrass to reach a 3″ height when compared to the control treatment and the ASET-4001 5% treatment. ASET-4001 5% treated Kentucky bluegrass reached a 3″ height faster than the untreated control by at least 2.5 days. Under water deficit conditions, seedlings from ASET treated seed grow more rapidly.

Perennial ryegrass seeds coated with ASET at both rates reached a 3″ height significantly faster than the uncoated seeds. Despite the reduced water input inflicted on the seedlings, the ASET-4001 5% and ASET-4001 20% coated seeds reached a 3″ height 4 days and 3 days faster than the untreated control. Under water deficit conditions, seedlings from ASET treated seed grow more rapidly.

Table 10a below shows the number of days for Kentucky bluegrass and perennial ryegrass to reach a 3″ height.

Days to 3″ Height

| Treatment | Kentucky Bluegrass | Perennial Ryegrass |
|---|---|---|
| ASET-4001 5% | 24.0 | 12.6 |
| ASET-4001 20% | 21.4 | 14.0 |
| Untreated | 27.2 | 17.0 |
| LSD (P = 0.05) | 1.53 | 0.88 |

Table 10b below shows the number of days for Kentucky bluegrass and perennial ryegrass to reach a 3″ height.

Days to 3″ Height

| Treatment | Kentucky bluegrass | Perennial Ryegrass |
|---|---|---|
| ASET-4002 5% | 21.8 | 17.0 |
| ASET-4002 20% | 22.2 | 13.6 |
| Untreated | 21.4 | 13.8 |
| LSD (P = 0.05) | 1.53 | 0.88 |

Biomass is a good indicator of seedling growth and plant health during stressful periods such as water restrictions. The greater the biomass, the greater the number of seedlings that emerged, covered the pots and remained healthy until the end of the trial. Both ASET-4001 treatments resulted in an increase in biomass for both turfgrasses species when grown under deficit irrigation in a wettable soil.

Table 11 a below shows Dry weight of Kentucky bluegrass and perennial ryegrass under deficit irrigation.

Dry weight (g)

| Treatment | Kentucky bluegrass | Perennial Ryegrass |
|---|---|---|
| Untreated | 0.120 | 0.181 |
| ASET-4001 5% | 0.242 | 0.279 |
| ASET-4001 20% | 0.220 | 0.252 |
| LSD (P = 0.05) | 0.207 | 0.106 |

The weight of Kentucky bluegrass biomass was not significantly enhanced by coating seeds with ASET-4002 5% or ASET-4002 20% however there was numerical trend for the coated technologies to increase dry weight matter when compared to the control. Perennial ryegrass biomass was significantly enhanced by the application of ASET-4002 20% compared to the control treatment. ASET-4002 5% coated seeds had dry weights intermediate between the control and ASET-4002 20% indicating a trend towards improved performance.

Table 11b below shows Dry weight of Kentucky bluegrass and perennial ryegrass.

Dry weight (g)

| Treatment | Kentucky bluegrass | Perennial Ryegrass |
|---|---|---|
| Untreated | 0.120 | 0.181 |
| ASET-4002 5% | 0.287 | 0.268 |
| ASET-4002 20% | 0.307 | 0.313 |
| LSD (P = 0.05) | 0.207 | 0.106 |

A severe water deficit trial on a wettable soil at The Pennsylvania State University-Reading, Pa. Greenhouse studies were conducted evaluating: Kentucky bluegrass and perennial ryegrass performance under deficit irrigation with and without an ASET-4001 seed coating at the 5% and 20% loading rate. The study was arranged as a randomized complete block design, with five replications of each treatment. Greenhouse pots were filled with a wettable silt loam soil, which is the most common soil type for most home lawns across the United States. Kentucky bluegrass and perennial ryegrass were seeded at 15 g N/m⁻² and 50 g N/m⁻². Seeds were placed on the soil, pressed, covered with more of the same soil and then immediately received 0.6 cm of water. All pots were watered with 0.6 cm of water once, again 4 days later and watered again only once a week thereafter. Severe water deficits were maintained by irrigating with only 0.6 cm water per week. No starter fertilizer was used. The same was repeated using ASET-4002 in place of ASET-4001

Measurement parameters consisted of seedling emergence, percent cover, seedling vigor, days to 3 inch height, and over-dry leaf clippings. Seedling emergence was conducted by counting shoots, until 20 shoots were evident. Thereafter, percent cover was used to evaluate emergence and rated visually on a scale of 0-100%. Seedling vigor was assessed as turf quality using a 1-9 visual rating where 1 means no emergence and 10 means healthy turf. Oven dry leaf clipping weights were assessed by removing entire leaf biomass (at the top of turf/soil interface) with scissors, placed in an envelope and oven dried at 105C for 72 hours. Dried clippings were then weighed. Days to 3 in height were determined as the number of days for >50% of seedlings to reach 3 inch height.

Under severe water deficit in a wettable soil, the first day for Kentucky bluegrass to emerge when treated with ASET-4001 5% and ASET-4001 20% was 8.0 and 9.8 days after planting, respectively. ASET-4001 5% emerged significantly faster when compared to the control treatment. Seed coatings on perennial ryegrass did not affect first emergence of the seedlings.

Table 12a below shows Days to first emergence for Kentucky bluegrass and perennial ryegrass under severe water deficits. The lower the number, the faster the germination.

Days to First Emergence

| Treatment | Kentucky bluegrass | Perennial Ryegrass |
|---|---|---|
| ASET-4001 5% | 8.0 | 4.0 |
| ASET-4001 20% | 9.8 | 4.2 |
| Untreated | 10.8 | 4.0 |
| LSD (P = 0.05) | 1.79 | 0.41 |

Under severe water deficits, emergence of ASET-4002 20% coated Kentucky bluegrass was significantly faster than uncoated seeds. ASET-4002 5% coated Kentucky bluegrass seeds emerged earlier than the control. In perennial ryegrass, no emergence effects were observed.

Table 12b below shows days to first emergence for Kentucky bluegrass and perennial ryegrass under severe water deficits. The lower the number, the faster the germination.

Days to First Emergence

| Treatment | Kentucky bluegrass | Perennial Ryegrass |
|---|---|---|
| ASET-4002 5% | 9.2 | 3.8 |
| ASET-4002 20% | 8.2 | 4.0 |
| Untreated | 10.8 | 4.0 |
| LSD (P = 0.05) | 1.79 | 0.41 |

Under severe water deficits, Kentucky bluegrass seedlings coated with ASET-4001 outperformed the untreated control. By 9 days after seeding, there were up to 9 times more seedlings in the ASET treatments. At the end of the study, (14 DAS), ASET-4001 5% and ASET-4001 20% significantly improved the number of seedlings that emerged when compared to the untreated control. The ASET-4001 technology nearly doubled the number of seedlings to emerge under severe water deficit when compared to the untreated seeds. In Kentucky bluegrass under severe water deficit, ASET treatment improved seedling densities.

Table 13a below shows Kentucky Bluegrass Seedling Counts under Severe Deficit Irrigation. Counts were recorded until >20 seedlings emerged.

| | Seedling Counts Days After Seeding (DAS) | | | | | |
|---|---|---|---|---|---|---|
| Treatments | 0 DAS | 3 DAS | 7 DAS | 8 DAS | 9 DAS | 14 DAS |
| Untreated | 0 | 0 | 0 | 0 | 0.6 | 12.2 |
| ASET-4001 | 0 | 0 | 0 | 1.6 | 5.6 | 22.8 |
| 5% | | | | | | |
| ASET-4001 | 0 | 0 | 0 | 0 | 4.2 | 23.6 |
| 20% | | | | | | |
| LSD (P = 0.05) | 0 | 0 | 0 | 1.35 | 7.07 | 10.45 |

ASET-4002 20% was the first seed to emerge when Kentucky bluegrass was exposed to severe water deficits. ASET-4002 20% coated seeds germinated 8 DAS which was significantly faster than all other treatments. No differences between ASET-4002 rates were observed on 9 and 14 DAS, but ASET-4002 20% exhibited significantly higher seedling counts compared to the control on 9 and 14 DAS. By 14 DAS, ASET-4002 5% also exhibited significantly higher seedling counts compared to the control. By 14 DAS, seedling counts were approximately 3 times greater when coated with the ASET technology treatments. ASET-4002 technology increased seedling counts and therefore improved seed survivability under severe water deficits.

Table 13b below shows Kentucky Bluegrass seedling counts under severe deficit irrigation. Counts were recorded until >20 seedlings emerged.

| | Seedling Counts Days After Seeding (DAS) | | | | | |
|---|---|---|---|---|---|---|
| Treatments | 0 DAS | 3 DAS | 7 DAS | 8 DAS | 9 DAS | 14 DAS |
| Untreated | 0 | 0 | 0 | 0 | 0.6 | 12.2 |
| ASET-4002 | 0 | 0 | 0 | 0 | 6.2 | 32.4 |
| 5% | | | | | | |
| ASET-4002 | 0 | 0 | 0 | 3.2 | 13.0 | 33.6 |
| 20% | | | | | | |
| LSD (P = 0.05) | 0 | 0 | 0 | 1.35 | 7.07 | 10.45 |

Table 14a below shows Perennial ryegrass seedling counts under severe deficit irrigation. Counts were recorded until >20 seedlings emerged. Treatment differences were statistically different on 5 DAS.

| | Seedling Counts Days After Seeding (DAS) | | | | |
|---|---|---|---|---|---|
| Treatments | 0 DAS | 3 DAS | 4 DAS | 5 DAS | 7 DAS |
| Untreated | 0 | 0 | 4.4 | 5.8 | 20.6 |
| ASET-4001 5% | 0 | 0 | 6.6 | 9.2 | 18.2 |
| ASET-4001 20% | 0 | 0 | 3.6 | 5.6 | 26.6 |
| LSD (P = 0.05) | 0 | 0 | 2.97 | 2.96 | 4.29 |

Perennial ryegrass seedlings were the first to emerge when coated with ASET-4002 5%.

Table 14b below shows Perennial ryegrass seedling counts under severe deficit irrigation. Counts were recorded until >20 seedlings emerged.

| | Seedling Counts Days After Seeding (DAS) | | | | |
|---|---|---|---|---|---|
| Treatments | 0 DAS | 3 DAS | 4 DAS | 5 DAS | 7 DAS |
| Untreated | 0 | 0 | 4.4 | 5.8 | 20.6 |
| ASET-4002 5% | 0 | 0.2 | 4.4 | 7.8 | 18.8 |
| ASET-4002 20% | 0 | 0 | 5.2 | 8.2 | 17.2 |
| LSD (P = 0.05) | 0 | 0 | 2.97 | 2.96 | 4.29 |

Under severe water deficits, ASET-4001 treatments significantly improved seedling vigor ratings within 9 days after seeding when compared to the untreated seed. By 28 DAS, highest seedling vigor ratings were observed in the ASET treatments. ASET-4001 20% significantly improved seedling vigor by 35% relative to the untreated control.

Table 15a below shows Effects of ASET-4001 on Kentucky bluegrass seedling vigor under severe deficit irrigation.

| | Seedling Vigor - Days After Seeding (DAS) | | | | | | | |
|---|---|---|---|---|---|---|---|---|
| Treatment | 0 DAS | 3 DAS | 7 DAS | 8 DAS | 9 DAS | 14 DAS | 21 DAS | 28 DAS |
| Untreated | 1.0 | 1.0 | 1.0 | 1.00 | 1.10 | 1.50 | 1.50 | 1.50 |
| ASET-4001 5% | 1.0 | 1.0 | 1.0 | 1.50 | 1.60 | 1.70 | 1.70 | 1.70 |
| ASET-4001 20% | 1.0 | 1.0 | 1.0 | 1.00 | 1.30 | 1.70 | 1.80 | 2.10 |
| LSD = P = 0.05 | 0.00 | 0.00 | 0.00 | 0.190 | 0.332 | 0.302 | 0.477 | 0.439 |

Kentucky bluegrass seedling vigor was significantly improved in the ASET-4002 20% treatment at 8 DAS, 9 DAS, 21 DAS and 28 DAS compared to the untreated seeds. Vigor was also significantly improved by the ASET-4002 5%, treatment, but only at 21 DAS and 28 DAS. Throughout the study, health and vigor of plants from coated seeds exhibited higher turfgrass quality under severe water deficits as compared to the control.

Table 15b below shows effects of ASET-4001 on Kentucky bluegrass seedling vigor under severe deficit irrigation.

| | Seedling Vigor - Days After Seeding (DAS) | | | | | | | |
|---|---|---|---|---|---|---|---|---|
| Treatment | 0 DAS | 3 DAS | 7 DAS | 8 DAS | 9 DAS | 14 DAS | 21 DAS | 28 DAS |
| Untreated | 1.0 | 1.0 | 1.0 | 1.00 | 1.10 | 1.50 | 1.50 | 1.50 |
| ASET-4002 5% | 1.0 | 1.0 | 1.0 | 1.00 | 1.40 | 1.70 | 2.20 | 2.20 |
| ASET-4002 20% | 1.0 | 1.0 | 1.0 | 1.50 | 1.60 | 2.00 | 2.30 | 2.20 |
| LSD = P = 0.05 | 0.00 | 0.00 | 0.00 | 0.190 | 0.332 | 0.302 | 0.477 | 0.439 |

In perennial ryegrass, differences in seedling vigor began to emerge at 14 DAS. By 21 DAS, seedling vigor in the ASET 5% and 20% loading were significantly greater than in the untreated control. When compared to the control, perennial ryegrass vigor was significantly improved by ASET-4001 20% at 14 DAS, 21 DAS, and 28 DAS while ASET-4001 5% significantly improved turfgrass health at 21 DAS and 28 DAS Three weeks after seeding, ASET technology enhanced turfgrass quality and maintained quality until the end of the trial under severe water deficit. ASET treatment significantly improved seedling vigor under severe water stress.

Table 16a below shows effects of ASET-4001 on perennial ryegrass seedling vigor under severe deficit irrigation.

| | Seedling Vigor - Days After Seeding (DAS) | | | | | | | |
|---|---|---|---|---|---|---|---|---|
| Treatment | 1 DAS | 3 DAS | 4 DAS | 5 DAS | 7 DAS | 14 DAS | 21 DAS | 28 DAS |
| Untreated | 1.0 | 1.0 | 2.00 | 2.00 | 1.60 | 1.80 | 2.40 | 2.90 |
| ASET4001 5% | 1.0 | 1.0 | 2.10 | 2.20 | 1.90 | 1.90 | 3.40 | 3.50 |
| ASET4001 20% | 1.0 | 1.0 | 1.90 | 2.10 | 1.50 | 2.20 | 3.40 | 3.60 |
| LSD = P = 0.05 | 0 | 0 | 0.441 | 0.250 | 0.277 | 0.351 | 0.551 | 0.486 |

ASET-4002 5% and ASET-4002 20% significantly improved perennial ryegrass vigor when compared to the control at 21 DAS and 14 DAS, respectively. After 4 DAS, plants from coated seeds tended to exhibit higher seedling vigor when compared to the control treatment under stressful water conditions.

Table 16b below shows effects of ASET-4001 on perennial ryegrass seedling vigor under severe deficit irrigation.

| | Seedling Vigor - Days After Seeding (DAS) | | | | | | | |
|---|---|---|---|---|---|---|---|---|
| Treatment | 1 DAS | 3 DAS | 4 DAS | 5 DAS | 7 DAS | 14 DAS | 21 DAS | 28 DAS |
| Untreated | 1.0 | 1.0 | 2.00 | 2.00 | 1.60 | 1.80 | 2.40 | 2.90 |
| ASET-4002 5% | 1.0 | 1.0 | 2.10 | 2.10 | 1.70 | 2.10 | 3.00 | 3.10 |
| ASET-4002 20% | 1.0 | 1.0 | 2.20 | 2.20 | 1.70 | 2.50 | 2.70 | 3.10 |
| LSD = P = 0.05 | 0 | 0 | 0.441 | 0.250 | 0.277 | 0.351 | 0.551 | 0.486 |

Percent cover declined when water inputs were reduced to meet severe deficit requirements of 0.60 cm/week. Although not significant at 21 DAS, Kentucky bluegrass seeds treated with ASET-4001 20% were twice as likely to establish under severe deficit irrigation when compared to the control treatment. At 28 DAS, the untreated seeds had stopped growing while both ASET treatments significantly improved Kentucky bluegrass establishment relative to the control.

Table 17a below shows percent cover of kentucky bluegrass under severe deficit irrigation.

Percent Cover

| Treatment | 21 DAS | 28 DAS |
|---|---|---|
| Untreated | .60 | .70 |
| ASET-4001 5% | .90 | 6.00 |
| ASET-4001 20% | 1.30 | 7.40 |
| LSD (P = 0.05) | 2.235 | 4.003 |

Severe water deficits inhibited percent cover of Kentucky bluegrass. However, seeds coated with either rate of ASET-4002, significantly improved turfgrass cover compared to the control treatment. On the last day of data collection, ASET-4002 5% and ASET-4002 20% coated seed exhibited 10 times greater cover than the control when water was a limiting factor.

Table 17b below shows percent cover of Kentucky bluegrass under severe deficit irrigation.

Percent Cover

| Treatment | 21 | 28 |
|---|---|---|
| Untreated | .60 | .70 |
| ASET-4002 5% | 3.00 | 10.00 |
| ASET-4002 20% | 4.20 | 11.00 |
| LSD (P = 0.05) | 2.235 | 4.003 |

Severe water deficits hindered percent cover for all perennial ryegrass treatments. Two weeks after seeding, both ASET-4001 treatments significantly improved percent cover of perennial ryegrass. Under severe water deficit in a wettable sand, percent cover of perennial ryegrass was less than 14% for all treatments.

Table 18a below shows percent cover of perennial ryegrass under severe deficit irrigation.

| | Percent Cover Days After Seeding (DAS) | | | |
|---|---|---|---|---|
| Treatment | 7 | 14 | 21 | 28 |
| Untreated | 1.4 | 2.6 | 9.0 | 11.0 |
| ASET-4001 5% | 1.0 | 4.4 | 10.0 | 10.0 |
| ASET-4001 20% | 1.0 | 5.0 | 10.0 | 13.0 |
| XXLSD (P = 0.05) | .30 | 1.71 | 5.52 | 4.90 |

Two weeks after seeding, ASET-4002 technology significantly improved turfgrass coverage when compared to the control. Thereafter, no treatment differences were visually apparent.

Table 18b below shows percent cover of perennial ryegrass under severe deficit irrigation.

| | Percent Cover Days After Seeding (DAS) | | | |
|---|---|---|---|---|
| Treatment | 7 | 14 | 21 | 28 |
| Untreated | 1.4 | 2.6 | 9.0 | 11.0 |
| ASET-4002 5% | 1.0 | 6.0 | 7.0 | 11.0 |
| ASET-4002 20% | 1.0 | 5.0 | 4.4 | 9.0 |
| LSD (P = 0.05) | .30 | 1.71 | 5.52 | 4.90 |

Severe water deficit reduced leaf biomass. Plants never reached 3″ height and leaf biomass was extremely minimal, therefore this data was not collected.

A deficit irrigation study on a wettable and water repellent sand was conducted at the University of Florida Fort Lauderdale, Fla. Two greenhouse studies were conducted at this site using perennial ryegrass and tall fescue. Both studies were initiated in May 2013 to evaluate the effect of soil (water-repellent or wettable), and irrigation regime on seeds coated with one of three rates of ASET-4001 (0%, 20% or 60% rate). Studies were arranged as a completely randomized design, having three replications per treatment. Soils consisted of a naturally water repellant soil collected from a Florida citrus grove (OGS) and a wettable sand (Sand). Water drop penetration tests indicate the degree of water repellency to be slight (<25 seconds) in the citrus grove soil. Greenhouse pots were filled with the corresponding soils and seeded at a rate of 100 g N/m⁻² for the perennial ryegrass, respectively. Water regimes include a high rate (0.6 cm every day) and a low rate (0.6 cm every other day). Seeds were not fertilized during this trial. At this location, the greenhouse is not temperature regulated and is an open design (full sun and wind exposure), therefore seeds were exposed to excessive temperatures ranging from 29° C. (85° F.)-over 43° C. (110° F.), high winds and full sun. Under the water regimes designated for this trial, the conditions presented at this location were extreme.

Perennial ryegrass sown on wettable sand and provided with optimum irrigation germinated significantly faster when coated with ASET-4001 W20 treatments. ASET-4001 W20 was the first and only treatment to reach 50% percent cover. Extreme temperatures and lack of water may explain the significant drop in percent cover for ASET-4001 W20 and the control treatments on May 21, 2013. However, ASET-4001 W20 coated seeds were able to rebound by 20% while the control only recovered by 6% of its former percent cover. Under water deficit conditions and extreme greenhouse temps (>38° C.), seeds coated with ASET-4001 W20 increased percent cover in a wettable soil.

Table 19a below shows percent cover (%) of perennial ryegrass on sand under “high” irrigation.

| Treatment | 5/13 | 5/14 | 5/16 | 5/21 | 5/28 | 6/4 |
|---|---|---|---|---|---|---|
| ASET-4001 | 6.3 | 9.7 | 55 | 31.7 | 51.7 | 41.7 |
| W20* | | | | | | |
| ASET-4001 | 0 | 1 | 6.7 | 13.3 | 23.3 | 20 |
| W60** | | | | | | |
| Control | 6.3 | 11.7 | 21.7 | 11.7 | 18.3 | 20 |
| Significance | P < 0.001 | P < 0.001 | P < 0.001 | P < 0.001 | P < 0.001 | P < 0.001 |

*ASET-4001 W20 represents the wet seed coating method at the 20% w/w weight.
**ASET-4001 W60 represents the wet seed coating method at the 60% w/w weight.

Uncoated seeds germinated faster and provided significantly higher percent cover on May 14, 2014 compared to all other treatments when perennial ryegrass was established on sandy soils that received optimum irrigation. Thereafter, ASET-4002 D20 coated seeds exhibited higher percent cover when compared to the all other treatments. Beginning on May 21 and continuing through June 4, the ASET-4002 D20 treatment exhibited significantly higher percent cover when compared to the control treatment. Under high irrigation and wettable soils but extreme greenhouse temperatures, ASET-4002 W20 coated seeds doubled percent cover of perennial ryegrass.

Table 19b below shows Percent cover for perennial ryegrass on sand on “high” irrigation.

| Treatment | 5/13 | 5/14 | 5/16 | 5/21 | 5/28 | 6/4 |
|---|---|---|---|---|---|---|
| ASET-4002 D20* | 3.3 | 6.3 | 25 | 25 | 36.7 | 41.7 |
| ASET-4002 D60** | 0 | 0.2 | 3.7 | 13.3 | 25 | 25 |
| Control | 6.3 | 11.7 | 21.7 | 11.7 | 18.3 | 20 |
| Significance | P < 0.001 | P < 0.001 | P < 0.001 | P < 0.001 | P < 0.001 | P < 0.001 |

*ASET-4002 D20 represents the wet seed coating method at the 20% w/w weight.
**ASET-4002 D60 represents the wet seed coating method at the 60% w/w weight.

For perennial ryegrass seeded in wettable sand under deficit irrigation, extreme greenhouse temperatures, full sun exposure, windy conditions, and deficit irrigation significantly reduced percent cover for all treatments.

Table 20a below shows percent cover (%) of perennial ryegrass on sand under deficit irrigation.

| Treatment | 5/13 | 5/14 | 5/16 | 5/21 | 5/28 | 6/4 |
|---|---|---|---|---|---|---|
| ASET-4001 W20* | 0 | 0.2 | 0.2 | 0.3 | 0.7 | 0 |
| ASET-4001 W60** | 0 | 0 | 0 | 1 | 1.7 | 0.7 |
| Control | 1.7 | 4.2 | 5.3 | 1.3 | 2.3 | 0.7 |
| Significance | P < 0.001 | P < 0.001 | P < 0.001 | P < 0.001 | P < 0.001 | P < 0.001 |

*ASET-4001 W20 represents the wet seed coating method at the 20% w/w weight.
**ASET-4001 W60 represents the wet seed coating method at the 60% w/w weight.

ASET-4002 D20 coated perennial ryegrass seeds sown in wettable sand and subjected to deficit irrigation, emerged faster and consistently provided better percent cover when compared to all other treatments. ASET-4002 D20 resulted in significantly higher percent cover compared to the control on four out of six observation periods and outperformed all other ASET formulations with the exception of ASET-4002 D60 on June 4. Despite deficit irrigation and extremely high greenhouse temperatures, ASET coated seeds resulted in 5 times higher percent cover when compared to the control treatment.

Table 20b below shows percent cover for perennial ryegrass on sand on deficit irrigation.

| Treatment | 5/13 | 5/14 | 5/16 | 5/21 | 5/28 | 6/4 |
|---|---|---|---|---|---|---|
| ASET-4002 D20* | 2.3 | 9 | 40 | 35 | 20 | 3.3 |
| ASET-4002 | 0 | 0.1 | 11.7 | 20 | 10 | 4.3 |
| D60** | | | | | | |
| Control | 1.7 | 4.2 | 5.3 | 1.3 | 2.3 | 0.7 |
| Significance | P < 0.001 | P < 0.001 | P < 0.001 | P < 0.001 | P < 0.001 | P < 0.001 |

*ASET-4002 D20 represents the wet seed coating method at the 20% w/w weight.
**ASET-4002 D60 represents the wet seed coating method at the 60% w/w weight.

For perennial ryegrass seeded on a slightly water repellant sand (OGS) and receiving high irrigation, emergence was significantly improved by the uncoated and ASET-4001 W20 treated seed on May 14, 2013. Thereafter, ASET-4001 W20 treated seed yielded significantly higher percent cover when compared to all other treatments, including the control. ASET-4001 W20 treated seed provided 6.5 times (May 16, 2013), 5 times (May 21, 2013), 4 times (May 28, 2013) and 2 times (Jun. 4, 2013) greater percent cover than the untreated seed even when irrigation levels were maintained to provide adequate moisture in a water repellent soil. Under extreme greenhouse temperatures (>38° C.), ASET-4001 W20 significantly improved emergence of perennial ryegrass sown on water repellent soil under optimal irrigation.

Table 21a below shows percent cover for perennial ryegrass on a water repellent orange grove sand on “high” irrigation regime.

| Treatment | 5/13 | 5/14 | 5/16 | 5/21 | 5/28 | 6/4 |
|---|---|---|---|---|---|---|
| ASET-4001 W20* | 0 | 6.3 | 43.3 | 56.7 | 63.3 | 36.7 |
| ASET-4001 W60** | 0 | 0 | 1 | 10 | 13.3 | 15 |
| Control | 0 | 4.7 | 6.7 | 11.7 | 15 | 20 |
| Significance | P < 0.001 | P < 0.001 | P < 0.001 | P < 0.001 | P < 0.001 | P < 0.001 |

*ASET-4001 W20 represents the wet seed coating method at the 20% w/w weight.
**ASET-4001 W60 represents the wet seed coating method at the 60% w/w weight.

On May 14, 2013, two days after seeding, ASET-4002 D20 and uncoated treatments had similar percent cover. The 60% ASET treatment slowed emergence compared to all other treatments seeded into a water repellent soil under optimum irrigation. Two days later, ASET-4002 W20 coated seeds provided at least 3 times better coverage versus all other treatments. By May 21, 2014 all ASET treatments resulted in significantly higher percent cover than the uncoated control. On the last day of data collection, after almost one month of extreme greenhouse temperatures and water repellent soils, ASET-4002 D20 significantly improved percent cover by 2 times when compared to the control treatment of perennial ryegrass in a water repellent soil under optimum irrigation.

Table 21b below shows percent cover for perennial ryegrass on water repellent orange grove sand on the “high” irrigation regime.

| Treatment | 5/13 | 5/14 | 5/16 | 5/21 | 5/28 | 6/4 |
|---|---|---|---|---|---|---|
| ASET-4002 D20* | 0 | 6.3 | 20 | 40 | 46.7 | 46.7 |
| ASET-4002 D6** | 0 | 0 | 1.5 | 30 | 36.7 | 21.7 |
| Control | 0 | 4.7 | 6.7 | 11.7 | 15 | 20 |
| Significance | P < 0.001 | P < 0.001 | P < 0.001 | P < 0.001 | P < 0.001 | P < 0.001 |

*ASET-4002 D20 represents the wet seed coating method at the 20% w/w weight.
**ASET-4002 D60 represents the wet seed coating method at the 60% w/w weight.

Perennial ryegrass seeded in a slightly water repellant sand (OGS) and receiving deficit irrigation, emerged significantly faster in the untreated and ASET-4001 W20 coated seed treatments when compared to ASET-4001 W60 on May 14, 2013. By May 16, ASET-4001 W20 significantly enhanced percent cover of perennial ryegrass on OGS under deficit irrigation when compared to the control treatment. Significant treatment differences were not observed for the rest of the trial. Extreme temperatures (>38° C.) in the greenhouse and reduced water may have limited the ability of the ASET-4001 W20 to maintain the higher percent cover due to the higher biomass requiring more water to sustain itself. It appears that the optimum yield of perennial ryegrass under these conditions would never be greater than 20%-25%. ASET-4001 W60 did not provide any benefit to the seed under these severe water deficit conditions. ASET-4001 W20 seed coating yielded significantly higher percent cover of perennial ryegrass but was not able to maintain the higher stand under these severe environmental conditions and non-wettable soil.

Table 22a below shows percent cover (%) of perennial ryegrass on a water repellent orange grove sand on deficit irrigation.

| Treatment | 5/13 | 5/14 | 5/16 | 5/21 | 5/28 | 6/4 |
|---|---|---|---|---|---|---|
| ASET-4001 | 0 | 4 | 28.3 | 35 | 21.7 | 20 |
| W20* | | | | | | |
| ASET-4001 | 0 | 0 | 0.5 | 5 | 2.3 | 1.7 |
| W60** | | | | | | |
| Control | 0 | 5.3 | 7 | 25 | 25 | 18.3 |
| Significance | P < 0.001 | P < 0.001 | P < 0.001 | P < 0.001 | P < 0.001 | P < 0.001 |

*ASET-4001 W20 represents the wet seed coating method at the 20% w/w weight.
**ASET-4001 W60 represents the wet seed coating method at the 60% w/w weight.

Two days after seeding, the control treatment exhibited significantly higher percent cover when compared to the control treatment. Two days later, ASET D20 resulted in significantly higher percent cover when compared to the control treatment. On May 28, 2014, percent cover was almost twice as high in ASET-4002 D20 when compared to the control. However, by the end of the trial, all treatments performed similarly under deficit irrigation on water repellent sand. The extreme temperatures and lack of water significantly reduced the percent cover of perennial ryegrass.

Table 22b below shows percent cover for Perennial Ryegrass on a water repellent Orange Grove Sand on deficit irrigation.

| Treatment | 5/13 | 5/14 | 5/16 | 5/21 | 5/28 | 6/4 |
|---|---|---|---|---|---|---|
| ASET-4002 D20* | 0 | 2.3 | 16.7 | 26.7 | 48.3 | 18.3 |
| ASET-4002 D60** | 0 | 0.1 | 0.3 | 15 | 16.7d | 21.7 |
| Control | 0 | 5.3 | 7 | 25 | 25 | 18.3 |
| Significance | P < 0.001 | P < 0.001 | P < 0.001 | P < 0.001 | P < 0.001 | P < 0.001 |

*ASET-4002 D20 represents the wet seed coating method at the 20% w/w weight.
**ASET-4002 D60 represents the wet seed coating method at the 60% w/w weight.

Further growth chamber studies were conducted at New Mexico State University, Las Cruces, N. Mex. Seashore paspalum cv. Sea Spray was evaluated in a growth chamber study. The germination experiment was conducted using a 1% Difco Bacto agar substrate. Salinity of the agar medium was adjusted to salinity levels of 0.6, 3.6, and 7.2 dS m-1. The salinity levels matched the levels of the irrigation water used in the corresponding field trial. The agar solution was autoclaved at 120° C. for 30 minutes prior to use. The agar was poured into 10 by 1.5 cm Fisherbrand® Petri dishes to which 36 seeds were transferred. Petri dishes were incubated in a germinator (Stults Scientific Engineering Corp., Springfield, Ill.), programmed to maintain alternating 8 h light at 8 h light at 35° C. with fluorescent light (36 μmol s-1 m-2) and 16 h dark at 20° C. for warm season grasses (AOSA, 2009). Germination data were collected three times per week for four weeks. A seed was considered germinated when the root and shoot could be observed with the naked eye. Germination rate (GR, % d-1) was based on seedling counts taken three times per week, and final germination percentage (FGP, %) was based on the total number of germinated seeds counted after 29 days. While FGP provides the total germination after the evaluation period of 4 weeks, GR describes the rate of germination, with higher values indicating faster rates.

Table 23 below shows final germination percentage of Seashore Paspalum.

Final Germination Percentage (%)

| | Salinity Levels | | |
|---|---|---|---|
| Treatments | .6 ds/m | 3.6 ds/m | 7.2 ds/m |
| ASET-4001 10% | 71.53 | 72.92 | 92.36 |
| ASET-4001 5% | 75.00 | 94.44 | 65.97 |
| Untreated | 46.53 | 72.20 | 63.00 |

Table 24 below shows germination rate of Seashore Paspalum.

Germination Rate %/d

| | Salinity Levels | | |
|---|---|---|---|
| Treatments | .6 ds/m | 3.6 ds/m | 7.2 ds/m |
| ASET-4001 10% | 5.4 | 5.1 | 7.6 |
| ASET-4001 5% | 5.5 | 6.4 | 7.9 |
| Untreated | 3.2 | 6.3 | 4.1 |

Final germination percentage of seashore paspalum was significantly greater at 0.6 ds/m when seeds were treated with ASET-4001. When seeds were placed in agar with 3.6 ds/m and 7.2 ds/m salinity levels, ASET-4001 5% and ASET-4001 10%, respectively, significantly increased seashore paspalum germination when compared to the control treatment. Germination rate or the percent of seeds that germinated on a daily basis was significantly enhanced at the 0.6 ds/m and 7.2 ds/m salinity levels when seeds were coated with ASET-4001 treatments.

Plastic round pots (8.75 cm×8.75 cm) were packed with 2.45 cm of top lip with #8 sieved Louisburg loam sand to a bulk density of 1.6 g/cm. Pots were seed with Festuca arundinacea (Tall fescue; variety “LS-1500”) at a rate of 0.238 grams of seed per pot. Seeds were spread evenly on top of soil surface and covered with 10 grams of soil. Pots were irrigated with (SAL) with either tap water (0.24 ds/m) or one of two saline water mixes (6 or 12 ds/m). The saline water mimicked the salt composition from off the coast of South Carolina (comprising of NaCl, MgSO4, MgCl, CaCl, NaHCO3, KCl). Pots were irrigated with 18 mL twice daily to maintain a moist substrate to a depth of 1.25 cm. On day 22, the irrigation rate was doubled to 36 mL per pot in order to maintain a moist substrate to a depth of 2.5 cm. Pots were fertilized on day 2 and say 15 with a 15-5-15 NPK fertilizer (Southern Ag) for a rate of 0.132 g of fertilizer per pot (0.5 lb. nitrogen 1000 sq.). The experimental design was randomized block design with two factors (ST and SAL) and replicated four times.

Percent cover was evaluated by a visual assessment after twenty shoots were observed. Percent cover was first assessed on Day 8, again on Day 9 and twice a week thereafter. To account for pots that had less than 20 shoots, a PC was assigned to them based on the number of shoots present. Pots with 1-10 shoots were assigned 1% cover and pots with 11-20 shoots were assigned 2% cover. For pots that did not germinate, a value of zero was assigned.

Table 25 below shows number of seeds per seed treatment for an application rate of 0.238 grams pot⁻¹. Values are average of weighing seeds three times each.

| Treatment | # of seed |
|---|---|
| Untreated | 106 |
| ASET-4001 5% | 51 |
| ASET-4001 10% | 55 |

Table 25 below shows Influence of Seed Treatment X Salinity Interaction on least square mean PC for rating days during the experimental period.

| Seed | | | | | | | | |
|---|---|---|---|---|---|---|---|---|
| Treatments | DAY | | | | | | | |
| X Salinity | 8 | 9 | 11 | 15 | 18 | 22 | 25 | 29 |

.24 ds/m

| | | | | | | | | |
|---|---|---|---|---|---|---|---|---|
| Untreated | 11.0 | 15.3 | 32.0 | 36.3 | 41.3 | 43.5 | 43.5 | 51.3 |
| 4001 5% | 6.3 | 10.3 | 22.8 | 25.8 | 28.8 | 29.5 | 29.5 | 32.3 |
| 4001 10% | 7.3 | 12.0 | 27.0 | 29.8 | 28.5 | 33.0 | 34.8 | 39.5 |

6 ds/m

| | | | | | | | | |
|---|---|---|---|---|---|---|---|---|
| Untreated | 0.3 | 0.8 | 1.3 | 2.5 | 3.3 | 3.3 | 3.3 | 3.3 |
| 4001 5% | 0.5 | 1.0 | 3.3 | 8.0 | 10.5 | 10.5 | 10.5 | 11.8 |
| 4001 10% | 1.0 | 2.5 | 9.8 | 12.3 | 14.3 | 29.5 | 16.3 | 16.8 |

12 ds/m

| | | | | | | | | |
|---|---|---|---|---|---|---|---|---|
| Untreated | 0 | 0 | 0 | 0.3 | 0.3 | 0 | 0 | 0 |
| 4001 5% | 0 | 0 | 0.3 | 0.3 | 0.3 | 0.3 | 0.3 | 0.3 |
| 4001 10% | 0 | 0 | 0 | 0 | 0.3 | 0.3 | 0.3 | 0.3 |
| Significance | .7759 | .4589 | .0084 | .0130 | .0065 | .0032 | .0049 | .0017 |

At 0.24 ds/m irrigation water, untreated seed significantly improved establishment of tall fescue when compared to the ASET treatments. However, seeding rates of the untreated control were twice that of the ASET treated seeds.

At 6 ds/m, 10 times the salinity of tap water, ASET-4001 10% significantly improved seed establishment when compared to all other treatments 11 days after initiation (Table 31). Thereafter, both ASET treatments that were seeded at half the rate as the untreated seeds significantly improved establishment of tall fescue under saline irrigation when compared to the control treatment. By the end of the trial, ASET treatments significantly improved establishment by 3 times and 5 times the rate of the untreated seed. At 12 ds/m, all treatments failed to reach maximum establishment at 20 times the salinity level of tap water.

The third set of studies, relating to salinity, follows.

For a Growth Chamber Study, the germination experiment was conducted using a 1% Difco Bacto agar substrate. Sodium chloride was used to create saline conditions of the agar. The salinity range of the agar medium was the following: 0.6 (tap water), 10 ds/m and 20 ds/m. As a point of reference for the reader, 10 ds/m and 20 ds/m are 17 times and 34 times more saline than normal tap water. Petri dishes were incubated in two different germinators, one for warm season grasses and a second for cool season grass. The incubators were programmed to maintain alternating 8 hours of light at 25° C. with fluorescent light (36 μmol s-1 m-2) and 16 h dark at 15° C. for cool season grasses, and 8 h light at 35° C. with fluorescent light (36 μmol s-1 m-2) and 16 h dark at 20° C. for warm season grasses. Germination data were collected two times per week for five weeks. A seed was considered germinated when the root and shoot could be observed with the naked eye. Final germination percentage (FGP) was based on the total number of germinated seeds counted after 36 days. FGP provides the total germination after the evaluation period of 5 weeks. Each treatment combination was replicated four times.

For a greenhouse study of emergence and establishment, the greenhouse experiment consisted of turfgrasses seeded into conical shaped, standard planting pots (15 cm in surface diameter and 15 cm in depth). The pots were filled with either a native sandy soil (hydrophilic) or a 10:1 mix (by weight) of sandy soil with ground peat moss (hydrophobic). The native soil consisted of a sandy loam, a sandy, skeletal, mixed, thermic Typic Torriorthent, an entisol typical for arid regions. The hydrophobic soil was prepared by air drying peat moss and soil separately at approximately 37° C. for one week. Both soil and peat were subsequently blended by weight at a ratio of 10 (soil):1 (peat moss) and dried for 2 hours at 185° C. which turned the rootzone hydrophobic. Pots were subsequently filled with the hydrophobic rootzone material to approximately 1 cm below the rim and seeded on Feb. 15, 2013, with 287 and 151 seeds/pot of perennial ryegrass and seashore paspalum, respectively. Seeding rates corresponded to 30 gr m⁻² (PR) and 5 gr m⁻² (SP). Grasses were irrigated with water at different salinity levels. Irrigation treatments included potable (tap) water (0.6 dS/m), and saline water at 10 and 20 dS/m. Sensors to measure solar radiation, air temperature, and relative humidity were mounted inside the greenhouse, connected to a datalogger, and used to monitor climatic conditions in the greenhouse.

Seedling emergence in each pot was counted on March 4 and on March 21. Beginning on March 5 [19 DAS (Days After Seeding)], a photograph of each pot was taken approximately every 14 days [March 15 (29 DAS), March 25 (39 DAS), April 9 (54 DAS), April 18 (63 DAS), April 30 (75 DAS), May 14 (DAS 89), May 28 (DAS 103), June 10 (DAS 116)] to determine total grass coverage. A 92 cm (length)×61 cm (width)×61 cm (height) metal box equipped on the inside with four 9 W lamps was used to provide equal and uniform lighting conditions for all the photographs taken. Turf coverage was determined using SigmaScan Pro 5 software (SPSS, 1998).

A scatter plot of coverage versus DAS suggested a nonlinear relationship between the two variables. A sigmoidal association was used to describe establishment of the turf pots (GraphPad Prism 5.0 for Windows; GraphPad Software, La Jolla, Calif.) over time and subsequently used to model maximum establishment 116 DAS.

The following was observed with respect to the Growth Chamber. ASET-4001 30% coating significantly enhanced final germination percent at 0.6 ds/m when compared to the untreated control. While differences between treatments were not significant under 10 ds/m and 20 ds/m, there was an observable trend for ASET coating to enhance final germination of seashore paspalum.

The following was observed with respect to Emergence. ASET-4001 30% coating significantly increased seashore paspalum emergence when compared the untreated control. Data was averaged over all salinity levels and 2 soil types. ASET-4001 60% did not separate itself from either ASET-4001 30% and the untreated seeds.

The following was observed with respect to establishment. Percent cover of seashore paspalum was significantly enhanced by ASET-4001 30% seed coating on every date collection date when compared to the control and on 4 of 5 collection dates when compared to ASET-4001 60%. From May 14, 2013 until the end of the trial, ASET-4001 60% significantly improved percent cover of seashore paspalum when compared to the control treatment. By the end of the trial, ASET-4001 30% seed coating increased percent cover by 1.5 times when compared to the control treatment. ASET-4001 technology increased stand establishment of seashore paspalum over two soil types and three salinity levels.

When seashore paspalum data were evaluated only under 3 salinity levels ASET-4001 seed coating at 30% and 60% rate significantly improved seashore paspalum establishment at 10 ds/m and 20 ds/m irrigation salinity levels when compared to the untreated control. Treatment differences were not significant at the 0.6 ds/m level. This data indicates that ASET-4001 technology will improve germination, emergence, and stand establishment at extreme irrigation salinity levels (10 ds/m and 20 ds/m).

ASET-4001 30% and ASET-4001 60% significantly improved percent cover of perennial ryegrass on every collection date when compared to the untreated control. ASET-4001 at both treatment rates increased stand establishment of perennial ryegrass over 2 soil types and 3 salinity levels.

When perennial ryegrass was evaluated only under three salinity levels, ASET-4001 30% significantly improved establishment at 0.6 ds/m and 10 ds/m irrigation salinity levels when compared to the control treatment. ASET-4001 60% significantly improved seashore paspalum green cover at 10 ds/m irrigation salinity level when compared to the control treatment. At the 20 ds/m irrigation salinity level, treatment separation was not significant. There were no significant differences between ASET technology treatments at any irrigation salinity level. ASET technologies significantly improved percent green cover 130 days after seeding under two irrigation salinity levels indicating this technology will help improve perennial ryegrass establishment under normal (0.6 ds/m) and severe (10 ds/m) salinity irrigation levels.

Accordingly, it can be summarized as follows. Under high saline irrigation conditions, ASET-4001 technology, particularly the ASET-4001 30% rate, significantly improved seashore paspalum germination and emergence. When stand establishment was evaluated, both seashore paspalum and perennial ryegrass significantly improved percent cover under a high saline environment. ASET surfactant technology may be used as a seed coating to improve crop germination and establishment when poor water quality is the only means for irrigation.

Table 26 below shows final germination (%) of surfactant coated and uncoated seashore paspalum at salinities of 0.6, 10, and 20 dS m⁻¹.

| | Germination (%) | | |
|---|---|---|---|
| | 0.6 dS/m | 10 dS/m | 20 dS/m |
| ASET-4001 30% | 77 | 42 | 8 |
| ASET-4001 60% | 52 | 38 | 15 |
| Uncoated | 44 | 33 | 3 |

Table 27 below shows seedling emergence (seedlings/pot) of surfactant coated and uncoated seashore paspalum. Data are averaged over 2 soil types and 3 salinity levels (0.6, 10, and 20 dS m⁻¹).

| | Seedlings/pot |
|---|---|
| ASET-4001 30% | 15 |
| ASET-4001 60% | 13 |
| Uncoated | 12 |

Table 28 shows establishment of seashore paspalum from surfactant coated seed. Data are averaged over 2 soil types and 3 salinity levels (0.6, 10, and 20 dS m⁻¹).

| | Percent cover % | | | | |
|---|---|---|---|---|---|
| Treatment | 18-Apr | 30-Apr | 14-May | 28-May | 10-June |
| ASET-4001 30% | 25 | 34 | 43 | 51 | 52 |
| ASET-4001 60% | 18 | 26 | 33 | 42 | 46 |
| Untreated | 14 | 20 | 24 | 29 | 34 |

Table 29 shows establishment of perennial ryegrass from surfactant coated seed. Data are averaged over two soil types and three salinity levels (0.6, 10, and 20 dS m⁻¹).

| | Percent cover % | | | | |
|---|---|---|---|---|---|
| Treatment | 18-Apr | 30-Apr | 14-May | 28-May | 10-June |
| ASET-4001 30% | 23 | 25 | 25 | 28 | 28 |
| ASET-4001 60% | 22 | 24 | 24 | 27 | 26 |
| Untreated | 14 | 16 | 16 | 18 | 18 |

Table 30 shows Turfgrass establishment (percentage of green cover 130 days after seeding) at three different irrigation salinity levels (0.6, 10, and 20 dS m⁻¹) of perennial ryegrass and seashore paspalum as affected by different amounts of surfactant seed coatings (ASET-4001). Percentage represents fraction of original seed weight added to uncoated seed by the seed coat. Values are pooled over two soil types and four replications.

| | Seashore | | | Perennial | | |
|---|---|---|---|---|---|---|
| | paspalum | | | ryegrass | | |
| Coating | 0.6 | 10 | 20 | 0.6 | 10 | 20 |
| ASET-4001 30% | 82 | 71 | 75 | 55 | 25 | 5 |
| ASET-4001 60% | 84 | 67 | 76 | 51 | 23 | 3 |
| Uncoated | 83 | 54 | 62 | 42 | 10 | 2 |

Seashore paspalum cv. Sea Spray was evaluated in a growth chamber study. The germination experiment was conducted using a 1% Difco Bacto agar substrate. Salinity of the agar medium was adjusted to salinity levels of 0.6, 3.6, and 7.2 dS m⁻¹. The salinity levels matched the levels of the irrigation water used in the corresponding field trial. The agar solution was autoclaved at 120° C. for 30 minutes prior to use. The agar was poured into 10 by 1.5 cm Fisherbrand® Petri dishes to which 36 seeds were transferred. Petri dishes were incubated in a germinator (Stults Scientific Engineering Corp., Springfield, Ill.), programmed to maintain alternating 8 h light at 8 h light at 35° C. with fluorescent light (36 μmol s⁻¹ m⁻²) and 16 h dark at 20° C. for warm season grasses (AOSA, 2009).

Germination data were collected three times per week for four weeks. A seed was considered germinated when the root and shoot could be observed with the naked eye. Germination rate (GR, % d⁻¹) was based on seedling counts taken three times per week (Maguire, 1962), and final germination percentage (FGP, %) was based on the total number of germinated seeds counted after 29 days. While FGP provides the total germination after the evaluation period of 4 weeks, GR describes the rate of germination, with higher values indicating faster rates.

Table 31 below shows final germination percentage of seashore paspalum.

Final Germination Percentage (%)

| | Salinity Levels | | |
|---|---|---|---|
| Treatments | .6 ds/m | 3.6 ds/m | 7.2 ds/m |
| ASET-4001 10% | 71.53 | 72.92 | 92.36 |
| ASET-4001 5% | 75.00 | 94.44 | 65.97 |
| Untreated | 46.53 | 72.20 | 63.00 |

Table 32 below shows the germination rate of seashore paspalum.

Germination Rate %/d

| | Salinity Levels | | |
|---|---|---|---|
| Treatments | .6 ds/m | 3.6 ds/m | 7.2 ds/m |
| ASET-4001 10% | 5.4 | 5.1 | 7.6 |
| ASET-4001 5% | 5.5 | 6.4 | 7.9 |
| Untreated | 3.2 | 6.3 | 4.1 |

Final germination percentage of seashore paspalum was significantly greater at 0.6 ds/m when seeds were treated with ASET-4001. When seeds were placed in agar with 3.6 ds/m and 7.2 ds/m salinity levels, ASET-4001 5% and ASET-4001 10%, respectively, significantly increased seashore paspalum germination when compared to the control treatment. Germination rate or the percent of seeds that germinated on a daily basis was significantly enhanced at the 0.6 ds/m and 7.2 ds/m salinity levels when seeds were coated with ASET-4001 treatments.

As used in this application, the word “about” for dimensions, weights, and other measures means a range that is ±10% of the stated value, more preferably ±5% of the stated value, and most preferably ±1% of the stated value, including all subranges therebetween.

The techniques described herein are exemplary, and should not be construed as implying any particular limitation on the present disclosure. It should be understood that various alternatives, combinations, and modifications could be devised by those skilled in the art from the present disclosure. For example, steps associated with the processes or methods described herein can be performed in any order, unless otherwise specified or dictated by the steps themselves. The present disclosure is intended to embrace all such alternatives, modifications, and variances that fall within the scope of the disclosure.

Claimed is:

1. A seed composition comprising:
a seed;
a binder;
a bioefficaciously effective amount of non-ionic surfactant; and
diatomaceous earth;
wherein the binder and the non-ionic surfactant are disposed in a first layer on the seed,
wherein the diatomaceous earth is disposed in a second layer on the first layer,
wherein the seed, the first layer, and the second layer, together in combination exhibit enhanced germination and plant growth compared to the seed alone in adverse soil conditions.

2. The seed composition of claim 1, wherein the non-ionic surfactant has an HLB value less than or equal to 10; an average molecular weight of from 2,000 to 8,000, and a percent hydrophile of from less than 10 to 40.

3. The seed composition of claim 1, wherein the non-ionic surfactant is a C1-C4 alkyl ether of methyl oxirane-oxirane copolymer.

4. The seed composition of claim 1, wherein the non-ionic surfactant is a blend of at least two surfactants selected from the group consisting of: an alkyl ether of methyl oxirane-oxirane copolymer, ethylene oxide-propylene oxide block copolymer, C₈-₁₀ Alkylpolyglucosides, Polyoxyethylene-Polyoxypropylene Block Co-polymer, and C₁-C₄ alkyl ether of ethylene oxide-propylene oxide block copolymer.

5. The seed composition of claim 1, wherein the binder is one selected from the group consisting of: polyvinyl alcohol (PVA), polymers and copolymers of polyvinyl acetate, vinylidene chloride, methyl cellulose, acrylic, cellulose, polyvinylpyrrolidone, and polysaccharide.

6. The seed composition of claim 1, wherein the binder is present at about 0.5% to about 1%.

7. The seed composition of claim 1, wherein the diatomaceous earth is present at about 5% to about 15%.

8. The seed composition of claim 1, wherein the bioefficaciously effective amount of non-ionic surfactant is about 0.1%.

9. The seed composition of claim 1, wherein the bioefficaciously effective amount of non-ionic surfactant is about 0.05 to 0.5%.

10. The seed composition of claim 1, wherein the enhanced germination and plant growth is in a soil with water deficit and results in more than about 1.5 times the seedling count than the seed alone.

11. The seed composition of claim 1, wherein the enhanced germination and plant growth is in a soil with an adverse saline condition and results in more than about 1.5 times the seedling count than the seed alone.

12. The seed composition of claim 1, wherein the enhanced germination and plant growth is in a soil with water deficit and results in more than about 1.5 times more above ground biomass than the seed alone.

13. The seed composition of claim 1, wherein the enhanced germination and plant growth is in a soil with water deficit and results in more than about 1.3 times percent coverage than the seed alone.

14. The seed composition of claim 1, wherein the enhanced germination and plant growth is in a soil with an adverse saline condition and results in more than about 1.5 times more percent coverage than the seed alone.

15. A method for improving seed germination and growth under elevated and/or depressed temperatures, the method comprising:
selecting an uncoated seed that will be subjected to adverse soil conditions;
preparing an aqueous composition, wherein the composition comprises a non-ionic surfactant and a binder
applying a coating of the aqueous composition to the uncoated seed, thus yielding a first-layer-coated seed;
dusting diatomaceous earth on the first-layer-coated seed, thus yielding a coated seed; and
drying the coated seed.

16. The method of claim 15, wherein the step of drying is performed at about 30 to 50 degrees Celsius.

17. The method of claim 15, wherein the step of drying is performed until the coated seed has a moisture content of about 1% to aboutl2%.

18. The method of claim 15, further comprising planting the coated seed in an adverse soil condition.

19. The method of claim 19, wherein the adverse soil condition is a water deficit.

20. The method of claim 19 wherein the adverse soil condition is a saline condition.
